(19) United States
(12) Patent Application Publication
(10) Pub. No.: US 2015/0188400 A1
(43) Pub. Date: Jul. 2, 2015

(54) Magnetic Flywheel Induction Engine-Motor-Generator

(71) Applicants: Robert Louis Kemp, Compton, CA (US); Thomas Edward Kemp, Cerritos, CA (US)

(72) Inventors: Robert Louis Kemp, Compton, CA (US); Thomas Edward Kemp, Cerritos, CA (US)

(21) Appl. No.: 14/145,292

(22) Filed: Dec. 31, 2013

(51) Int. Cl. H02K 47/14; H02K 1/02; H02K 49/10; H02K 7/02

(52) U.S. Cl. CPC H02K 47/14; H02K 7/025; H02K 1/02; H02K 49/102; Y10S 74/09; H02K 53/00

(57) ABSTRACT

This invented apparatus, and process of “Magnetic Induction” combines a plurality of electrical motors, flywheel kinetic energy, and a geometrical arrangement of permanent magnets in interaction, such as to recover and harvest a percentage, of the wasted rotational energy generated by powering a motor with a shaft.

The invention is a geometric arrangement, where one system of north-pole facing permanent magnet system, rotates about a shaft axis, separated by a fixed air gap distance, from a second, south-pole facing, permanent magnet system.

When the apparatus, and the first “north-pole” permanent magnet magnetic system, is motor powered into rotation, relative to a second unpowered “south-pole” permanent magnet system; “Magnetic Induction” occurs in the second adjacent unpowered south-pole permanent magnet system, which rotates in the opposite direction, to the initial rotation that caused or induced the rotation.

### CROSS-REFERENCE TO RELATED APPLICATIONS

Benefit is claimed respecting the following provisional patent application numbers (Patent Nos.). The disclosures of which are hereby incorporated by reference herein in their entireties, and all commonly owned.

| | |
|---|---|
| U.S. Pat. No. 3,899,703 to Kinnison | filed: August 1975 |
| U.S. Pat. No. 4,151,431 to Johnson | filed: April 1979 |
| U.S. Pat. No. 4,300,067 to Schumann | filed: November 1981 |
| U.S. Pat. No. 6,741,440 to O'Brien | filed: May 2004 |
| U.S. Pat. No. 6,867,514 to Fecera | filed: March 2005 |
| U.S. Pat. No. 8,508,089 to Edwards | filed: August 2013 |

All above provisional applications are related to the present invention by virtue of describing means for permanent magnet motion.

### FIELD OF THE INVENTION

The present invention generally relates to devices and methods employing motors/generators/alternators, flywheel kinetic energy, permanent magnets, and rotary magnetic fields, for the purposes of providing a driving force, and for enhancing power from a motor, used for generating direct current (DC) electrical power, alternating current (AC) electrical power, recharging of rechargeable batteries, and acts as a mechanical mover doing work, which includes: turning a rotor, gear, pulley, tire rim, fan, or drive wheel, pumps, propellers, motors, propel vehicles, and various mechanical and electromechanically devices, not mentioned herein.

### BACKGROUND OF THE INVENTION

The use of a magnetic field to provide a mechanical driving force, and to function as a permanent magnet motoring device is well known in the prior art. The renewable electrical power technologies like solar, wind, and thermal, are now truly competing sources for delivering energy/power in today's market place. And concerns for protecting the environment, have led to increased efforts in developing alternative sources for supplying energy to drive these new power systems, for which permanent magnet motion devices, provide novel solutions.

The invention described herein is a new magnetic energy/power system technology that is great for the environment, eliminates the need for fossil fuels, and works well with solar, wind and thermally generated electric power. The invention described herein is an energy/power generating apparatus, which utilizes permanent magnet motion, and the physics of magnetic induction.

A permanent magnet motion apparatus as described herein uses electromagnets or permanent magnets arranged in a rotatable flywheel system, in conjunction with electrical motors/generators/alternators, is constructed to function as an engine-motor-generator.

Permanent Magnetic Motion Motors are known in the prior art. Former examples of permanent magnet motors include, U.S. Pat. No. 6,867,514 granted to Fecera; where it discloses, a motor providing unidirectional rotational motive power. The motor also includes one or more stator magnets attached to the outer surface of the stator. The stator magnets are arranged in a generally circular arrangement about the stator axis and generate a first magnetic field. An armature which is attached to the stator for rotation has an axis which is parallel to the stator axis. One or more rotors, are spaced from the armature and coupled thereto by an axle for rotation about an axis of each rotor, each rotor rotates in a plane generally aligned with the armature axis. Each rotor includes one or more rotor magnets, with each rotor magnet generating a second magnetic field. The second magnetic field generated by each rotor magnet interacts with the first magnetic field to cause each rotor to rotate about the rotor axis. A linkage assembly drivingly connects each rotor to the stator to cause the armature to rotate about the armature axis to provide the unidirectional rotational motive power of the motor.

The “Magnetic Induction”, invention presented herein is different from above, in that Fecera, uses stators, armatures, and linkages for magnetic motor drive; and this design is common in electric motors/generators/alternators. The invention being presented herein does not use a stator, armature, or linkage for permanent magnetic motion drive operation, or electrical power generation. And therefore uses different physics from that which is being used in the apparatus invented by Fecera, as compared to the magnetic induction physics employed by described invention.

Likewise, there is the U.S. Pat. No. 4,300,067 granted to Schumann; where it discloses, a permanent magnet motion conversion device which includes spaced stationary permanent magnets and a carriage having permanent magnets located adjacent to the ends of the carriage. The carriage shuttles back and forth between the permanent magnets at the end of the carriage, as a result of magnetic repulsion when shield plates are moved into and out of shielding positions in front of the stationary magnets.

The “Magnetic Induction”, invention presented herein is different from above, in that Schumann, uses linear motion and a carriage which shuttles back with magnetic repulsion recoil, bouncing with shock absorbers back and forth. The invention being presented herein uses only rotary motion, and there is no side to side motion linear necessary for permanent magnetic motion drive operation, or electrical power generation.

Likewise, there is the U.S. Pat. No. 8,508,089 granted to Edwards; where it discloses, a permanent magnet apparatus, which is rotated about an axis, extending between opposing north and south poles. The magnetic field of the rotated permanent magnet interacts with magnetic fields of permanent magnets carried by a shuttle for repelling and attracting the fixed permanent magnets, and providing a linear reciprocating movement of the shuttle responsive to the rotary motion of the rotated permanent magnet.

The “Magnetic Induction”, invention presented herein is different from above, in that Edwards similar to Schumann above, is providing a force of repulsion, where the driving force is the linear reciprocating movement of the shuttle, which is responsive to the rotary motion of the rotated permanent magnet.

The “Magnetic Induction” invention being presented herein uses only rotary permanent magnet motion, and the force of attraction, between the “monopole” north and south poles of the magnets, eliminating any need for side to side linear motion, during permanent magnetic motion rotating drive operation.

Similarly, there is also U.S. Pat. No. 3,899,703 granted to Kinnison; where it discloses a magnetic motor having at least one drive unit including first and second stationary magnets arranged with inverse directions of polarity and a movable magnet mounted for movement within the magnetic fields of the first and second stationary magnets. A diverter device is switched between two positions for alternately diverting the magnetic fields of the first and second stationary magnets. The movable magnet is alternately switched into alignment with the first and second stationary magnets, while the diverter diverts the magnetic field from the other magnet. In this manner a repulsion force is created which causes the continued movement of the movable magnet.

The “Magnetic Induction” invention presented herein is different from above, in that Kinnison similar to Schumann, uses a diverter switching device, where a movable magnet is alternately switched between two positions for alternately aligning the magnetic fields, this in turn creates a repulsion force which causes the continued movement of the movable magnet.

The “Magnetic Induction” invention being presented herein uses only rotary permanent magnetic motion of the magnetic fields which create the continued movement of the flywheel rotor. When invention is further compared to Kinnison, and Schumann, there are no diverting devices or switches necessary to align the magnetic fields during any period of magnetic interaction and rotation. The invention uses drive motors, and the on axis magnetic induction force, between the magnetic monopoles, which in comparison, are always aligned during rotation, which creates the induced rotary permanent magnet motion.

Furthermore, there is U.S. Pat. No. 4,151,431 granted to Johnson; where it discloses, a method of utilizing the unpaired electron spins in ferro magnetic and other materials as a source of magnetic fields for producing power without any electron flow as occurs in normal conductors, and to permanent magnet motors for utilizing this method to produce a power source.

Johnson discloses in the invention that unpaired electron spins occurring within permanent magnets are utilized to produce a motive power source solely through the superconducting characteristics of a permanent magnet and the magnetic flux created by the magnets are controlled and concentrated to orient the magnetic forces generated in such a manner to do useful continuous work, such as the displacement of a rotor with respect to a stator. The timing and orientation of magnetic forces at the rotor and stator components produced by permanent magnets to produce a motor is accomplished with the proper geometrical relationship of these components.

The Magnetic Induction, invention presented herein is different from above, in that Johnson, uses superconducting magnets, and stators, for magnetic motor drive. The invention being presented herein does not use superconducting magnets, or a stator, for permanent magnetic motion drive operation, or electrical power generation.

Furthermore, there is U.S. Pat. No. 6,741,440 granted to O'Brien; where it discloses, a magnetization method and apparatus which is described as utilizing a pair of mechanically counter-vibrated permanent magnets having mutually facing unlike magnetic poles, and wherein a ferromagnetic article, or article containing ferromagnetic elements in close-set array, is placed for subjection to a pulsed magnetizing flux between the pair of counter-vibrated magnets. Uses of the invention include making magnets and modifying the current drain property of a multi-plate nickel-metal hydride battery.

The Magnetic Induction, invention presented therein is different from above, in that O'Brien, uses mechanically counter-vibrated permanent magnets, and wherein a ferromagnetic article, or article containing ferromagnetic elements in close-set array, is placed for subjection to pulsed magnetizing flux between the pair of counter-vibrated magnets.

The invention being presented herein uses, rotary permanent magnet motion, and no vibration or pulses of any specified value are required, nor is any ferromagnetic material required to be placed between the rotating magnetic fields, for normal operation of apparatus.

However, the invented apparatus similar to O'Brien, has been observed producing an effect of electric induction, or electromagnetic induction when a rechargeable battery source, and or its external battery components, and or coils of wire, are placed between, or in the local vicinity of the rotating magnetic fields, of the “Magnetic Flywheel Induction Rotors”; a magnetic-mechanical apparatus, used to construct invention for electrical power generation, and mechanical work output.

Attempts continue to be sought for new and improved designs and inventions of permanent magnetic motor apparatus, which can be economically and efficiently operated for providing electrical and mechanical power.

The claims made of the invented permanent magnetic motor apparatus described herein, provides an efficient means of generating AC/DC electrical energy and mechanical energy, using a plurality of electric motors/generators/alternators, flywheel kinetic energy, and Neodymium-Iron-Boron (NdFeB) permanent magnets; which when combined and constructed into invented apparatus, results in a conserved system with high efficiency output energy/power, when compared to the input energy/power to the apparatus.

Furthermore the invention described herein describes new physics, not presently described in current text books. Currently the text books describe the interaction of magnetic forces acting on moving electric charges, currents, conducting wires, and coils. This phenomenon is known as Electric Induction or Electromagnetic Induction.

The invention claimed herein demonstrates the new physics of magnetic forces acting on rotating permanent magnets; this phenomenon is introduced herein as Magnetic Induction; permanent magnet motion.

The invention claimed herein uses “Magnetic Induction”, the physics of magnetic forces acting on rotary permanent magnets, and rotating magnetic fields, which produces permanent magnet motion, for the useful purposes of generating direct current (DC) electrical power, alternating current (AC) electrical power, recharging rechargeable batteries, and acts as a mechanical mover doing work, which includes: turning a rotor, gear, pulley, tire rim, fan, or drive wheel, pumps, propellers, motors, propel vehicles, and various mechanical and electromechanically devices, not mentioned herein.

### SUMMARY OF THE INVENTION

The invention herein makes the claims for a richer understanding of ferromagnetic physics, and incorporates a unique “Magnetic Induction” process, and method for measuring the magnetic interaction force between permanent magnets bodies, acting on rotating permanent magnet bodies, and a new method for calculating the value of “Magnetic Charge”, “Magnetic Permeability” and “Relative Permeability” on the surface, and in the surrounding medium space, of permanent magnet bodies in interaction with other permanent magnet bodies.

The invention described therein employs a magnetic induction process, flywheel kinetic energy, permanent magnet flywheel rotors, and a plurality of electric motors/generators/alternators, for the general purpose of generating DC/AC electrical power, and/or acts as a mechanical mover, which includes stationary mechanical work, and the propelling of vehicles/aircraft/marine, a form of dynamic mechanical work.

The invention, “Magnetic Flywheel Induction Engine-Motor-Generator”, is architected in a limited scope “System Design”, when combing a “Charge Controller” in conjunction with a “Rechargeable Battery” source, connected to the output of the “Magnetic Flywheel Induction Engine-Motor-Generator”.

Given, the system is powered by a “Rechargeable Battery” source, the “system” reacts “self-sustaining” by connecting the electrical output, from one or more of the “DC/AC Electrical Motors/Generators/Alternators”, to a “Charge Controller”, or directly to the “Rechargeable Battery” source.

The above “self-sustaining” design is very similar the electrical battery charging system in an automobile/car; where the car's alternator, is connected to the turning engine, and the battery. And as long as the car's engine is turning, the alternator is generating electricity, and recharges the battery.

The invention further claims that “self-sustaining” is accomplished, when “input” power into the “Charge Controller” or the “Rechargeable Battery”, is from the “output” power of one or more, of the “DC/AC Electrical Motors/Generators/Alternator/s”, of the “Magnetic Flywheel Induction Engine-Motor-Generator”.

The “self-sustaining” is further accomplished, when the “output” power from the “Charge Controller” or the “Rechargeable Battery” source, is fed back as “input” via the “Motor Controller” and/or “Drive Motors”, of the “Magnetic Flywheel Induction Engine-Motor-Generator”.

The remaining “DC/AC Electrical Motors/Generators/Alternator/s”, output power of the “Magnetic Flywheel Induction Engine-Motor-Generator”, allows the apparatus to function as a “power-plant” and generator, which is “self-sustaining” while it produces AC/DC electrical power.

A different hierarchy of the invented apparatus; the “Magnetic Flywheel Induction Engine-Motor-Generator”, is an apparatus that combines a plurality of motors/generators/alternators, and rotary permanent magnet motion flywheel rotors; which when constructed, functions as a apparatus that allows a percentage of the wasted rotational energy, from a “first”, powered “Magnetic Flywheel Engine-Motor-Generator”, to be recoverable, and harvested, by a “second” adjacent, unpowered “Magnetic Flywheel Engine-Motor-Generator”.

A “Magnetic Flywheel Engine-Motor-Generator” described in general and limited scope, is constructed of three main components: one or more (1) “Magnetic Flywheel Induction Rotors”, and one or more (1) “Drive Motor/s” with extended shafts, which includes dual shafts motors, and one or more (1) “Motor/Generator/Alternators”.

A single “Magnetic Flywheel Induction Rotor”, in general, is a permanent magnet rotatable apparatus, which rotates about two (2) motor shafts axis; where motors/generators/alternators are attached, connected, and positioned with shaft oppositely (shaft facing shaft), and connected to the left and right sides of the “Magnetic Flywheel Induction Rotors”.

Two or more “Magnetic Flywheel Engine-Motor-Generators” placed side by side adjacently, and with, the “Magnetic Flywheel Induction Rotors” separated by a fixed “Air Gap Distance”, from each other, this creates the apparatus known as a “Magnetic Flywheel Induction-Engine-Motor-Generator”.

Describing the invention in limited scope, a “Magnetic Flywheel Induction-Engine-Motor-Generator”, which is a conserved and closed system design, that consists of a minimum of four (4) motors/generators/alternators with shafts, and two (2) adjacent rotatable “Magnetic Flywheel Induction Rotors”, each connected to motor shafts, and separated by a fixed “Air Gap Distance”, from each rotor permanent magnet surface; and constructed such that one or more of the system components are “Drive Motor/s”, and the other “motors/generators/alternators” are used for recharging the source batteries, and likewise provides a means for supplying apparatus generated AC/DC electrical energy and power.

Although a “Magnetic Flywheel Induction Engine-Motor-Generator”, is constructed from a plurality of motors/generators/alternators, the system only needs one “Drive Motor” to be powered, to physically operate; although more than one motor could be considered “Drive Motor/s” to physically operate.

Each “Magnetic Flywheel Inductor Rotor” has a specific geometric block shape, with a minimum of six sides, if the block is square. Two sides of the rotor block are reserved for mounting the motors/generators/alternators to the rotor block. And the remaining sides of the rotor block are reserved for attaching a set of permanent magnets, with identical or like poles facing; and this creates a magnetic monopole flywheel apparatus. The set of permanent magnets, are attached to each top, bottom, front, and rear side, and thus, arranged around the circumference of each flywheel rotor.

The geometric shape of the “Magnetic Flywheel Induction Rotor Blocks” designates the number of sides of the block, which are facets that denote the number of permanent magnet surfaces. The more facets there are to the “Magnetic Flywheel Induction Rotor Blocks”, the faster rotor block rotates, and the greater the output efficiency of the “Magnetic Flywheel Induction Engine-Motor-Generator”.

The greater the number of “Magnetic Flywheel Induction Rotor”, facets or permanent magnet surfaces, the greater the motor speed control and the less torque required by the drive motor, to initiate magnetic induction; and this also results is greater output power generated, from the “Magnetic Flywheel Induction Engine-Motor-Generator”.

Furthermore, building “Magnetic Flywheel Induction Engine-Motor-Generators”, with unequal rotary magnetic fields, and letting the unpowered Magnetic Flywheel Induction Rotors, have the smaller magnetic field strength, and letting the drive motor, have the larger magnetic field strength, this greatly, increases the output efficiency of the apparatus.

The unequal rotary magnetic field, “Magnetic Flywheel Induction Engine-Motor-Generator” design, also, provides for greater motor speed control, and less torque is required by the drive motor, to initiate magnetic induction; likewise there is greater output power generated by the apparatus.

The Magnetic Flywheel Induction Rotors, are constructed with the permanent magnets attached to the rotor surfaces, such that there is a north-pole facing on one flywheel rotor, and an unlike south-pole facing, on the second flywheel rotor.

The south-pole magnetic fields of the second flywheel rotor interact with the north-pole magnetic fields of first flywheel rotor, only through a fixed air gap distance; and no other physical contact.

The unlike poles of the permanent magnets are positioned around the circumference of each magnetic flywheel inductor rotor, such that the powered flywheel rotor, once it is set rotating about its own set of motors shafts axis, attracts the second unpowered flywheel rotor. And by magnetic induction, the second unpowered magnet system is set in motion rotating about its own set of motors shafts axis.

The result is magnetically induced rotation of the unpowered magnetic flywheel inductor rotor. The induced rotation of the unpowered motor then induces a secondary motion into the overall rotation; and when the “Magnetic Flywheel Induction Rotors” are attached to motors/generators/alternators, can be used for generating direct current (DC) electrical power, alternating current (AC) electrical power, and acts as a mechanical mover doing work, which includes: turning a rotor, gear, pulley, tire rim, fan, or drive wheel, pumps, propellers, motors, propel vehicles/aircraft/marine, and various mechanical and electromechanically devices, not mentioned herein.

The energy generated from magnetically induced rotation of the unpowered “Magnetic Flywheel Inductor Rotor”, is harvested from the wasted mechanical rotational energy lost by the “Drive Motor/s” which power, the initial rotation of the Magnetic Flywheel Inductor Rotors”.

### BRIEF DESCRIPTION OF THE DRAWINGS

For a greater in depth, understanding of the invention, reference is made to the following detailed description and accompanying drawings, of various embodiments of the declared invention, wherein:

FIG. 1: is a top and bottom plan view of two (2) Magnetic Flywheel Induction Rotors and an Air Gap distance separating the two rotors, embodiment of the invention;

FIG. 2: is a left and right side view of two (2) Magnetic Flywheel Induction Rotors, Rotor Shaft Mounting Connecting Hubs with Turbine Blades/Propellers used for cooling the motors/generators/alternators, and an Air Gap distance separating the two Square Block Rotors, embodiment of the invention;

FIG. 3: is a left and right side view of two (2) Magnetic Flywheel Induction Rotors and an Air Gap distance separating the two Hexagon Block Rotors, embodiment of the invention;

FIG. 4: is a left and right side view of two (2) Magnetic Flywheel Induction Rotors and an Air Gap distance separating the two Pentagon Block Rotors, embodiment of the invention;

FIG. 5: is a front and rear side schematic view of a single Magnetic Flywheel Induction Rotor, and the “limited scope” attachment assembly of the permanent magnets affixed to circumference sides of the Rotor Block, embodiment of the invention;

FIG. 6: is a front and rear side view of Magnetic Flywheel Engine-Motor-Generator, limited scope embodiment of the invention;

FIG. 7: is a top plan view of Magnetic Flywheel Induction Engine-Motor-Generator, constructed of two (2) adjacent Magnetic Flywheel Engine-Motor-Generators, two (2) Magnetic Flywheel Induction Rotors, one (1) Electrical Drive Motor, and three (3) DC/AC Electrical Motors/Generators/Alternators, limited scope embodiment of the invention;

FIG. 8: is a top plan view of Magnetic Flywheel Induction Engine-Motor-Generator, with an optional vacuum/pump chamber attachment, embodiment of the invention;

FIG. 9: is a top plan view of Magnetic Flywheel Induction Engine-Motor-Generator, constructed of three (3) adjacent Magnetic Flywheel Engine-Motor-Generators, three (3) Magnetic Flywheel Induction Rotors, one (1) Electrical Drive Motor, and five (5) DC/AC Electrical Motors/Generators/Alternators, limited scope embodiment of the invention;

FIG. 10: is a top plan view of Magnetic Flywheel Induction Engine-Motor-Generator, with two (2) Magnetic Flywheel Induction Rotors, one (1) Electrical Drive Motor, located on far end of apparatus, and one (1) adjacent Magnetic Flywheel Engine-Motor-Generator, with Electrical Generator connected to adjacent Pulley Wheel Drive Assembly, for a total of five (5) DC/AC Electric Motors/Generators/Alternators, limited scope embodiment of the invention;

FIG. 11: is a top plan view of Magnetic Flywheel Induction Engine-Motor-Generator, with two (2) Magnetic Flywheel Induction Rotors, one (1) Electrical Drive Motor, located in the center of apparatus, and one (1) adjacent Magnetic Flywheel Engine-Motor-Generator, with Electrical Generator connected to adjacent Pulley Wheel Drive Assembly, for a total of five (5) DC/AC Electric Motors/Generators/Alternators, limited scope embodiment of the invention;

FIG. 12: is a top plan view of Magnetic Flywheel Induction Engine-Motor-Generator, constructed of two (2) adjacent Magnetic Flywheel Engine-Motor-Generators, two (2) Magnetic Flywheel Induction Rotors, one (1) Electric Drive Motor, connected to adjacent Pulley Wheel Drive Assembly, and three (3) DC/AC Electrical Motors/Generators/Alternators, limited scope embodiment of the invention;

FIG. 13: is a left and right side view of Magnetic Flywheel Induction Rotor, and Gear Wheel Drive Assembly, limited scope embodiment of the invention;

FIG. 14: is a left and right side view of Magnetic Flywheel Induction Rotor, and Pulley Wheel Drive Assembly, limited scope embodiment of the invention;

FIG. 15: is a top plan view of Magnetic Flywheel Engine-Motor-Generator, constructed of two (2) Magnetic Flywheel Induction Rotors, one (1) Dual Shafts Electrical Drive Motor, and two (2) DC/AC Electrical Motors/Generators/Alternators, depicted connecting the output of the apparatus, to a Charge Controller, which re-charges the battery, while simultaneously providing electrical and mechanical power output, limited scope embodiment of the invention;

FIG. 16: is a top plan view of Magnetic Flywheel Induction Engine-Motor-Generator, constructed of two (2) adjacent Magnetic Flywheel Engine-Motor-Generators, four (4) Magnetic Flywheel Induction Rotors, two (2) Dual Shafts Electrical Drive Motors, and four (4) DC/AC Electrical Motors/Generators/Alternators, depicted connecting the output of the apparatus, to a Charge Controller, which re-charges the battery, while simultaneously providing electrical and mechanical power output, limited scope embodiment of the invention;

FIG. 17: is a top plan view of Magnetic Flywheel Induction Engine-Motor-Generator, constructed of three (3) adjacent Magnetic Flywheel Engine-Motor-Generators, six (6) Magnetic Flywheel Induction Rotors, three (3) Dual Shafts Electrical Drive Motors, and six (6) DC/AC Electrical Motors/Generators/Alternators, depicted connecting the output of the apparatus, to a Charge Controller, which re-charges the battery, while simultaneously providing electrical and mechanical power output, limited scope embodiment of the invention;

FIG. 18: is a top plan view of Magnetic Flywheel Induction Engine-Motor-Generator, constructed of one (1) Magnetic Flywheel Engine-Motor-Generator, four (4) Magnetic Flywheel Induction Rotors, one (1) Dual Shafts Electrical Drive Motor, and six (6) DC/AC Electrical Motors/Generators/Alternators, depicted connecting the output of the apparatus, to a Charge Controller, which re-charges the battery, while simultaneously providing electrical and mechanical power output, limited scope embodiment of the invention;

FIG. 19: is a top plan view of Magnetic Flywheel Induction Engine-Motor-Generator, constructed of one (1) adjacent Magnetic Flywheel Engine-Motor-Generators, six (6) Magnetic Flywheel Induction Rotors, one (1) Dual Shafts Electrical Drive Motor, and ten (10) DC/AC Electrical Motors/Generators/Alternators, depicted connecting the output of the apparatus, to a Charge Controller, which re-charges the battery, while simultaneously providing electrical and mechanical power output, limited scope embodiment of the invention;

FIG. 20: is a mathematical formulation and prediction of Magnetic Fields (B) vs. Shaft Axial Rotation Angle (β); for each rotating Magnetic Flywheel Induction Rotor.
The Shaft Axial Rotation Angle (β), is the angle between a line drawn normal to the rotary magnetic field surface area, and a horizontal line drawn in the “Air Gap Distance” which separates the magnetic surfaces in the “Air Gap Distance”;

FIG. 21: is a mathematical formulation and prediction of Magnetic Relative Permeability (p) vs. Shaft Axial Rotation Angle (β); for each rotating Magnetic Flywheel Induction Rotor;

FIG. 22: is a mathematical formulation and prediction of Magnetic Charge (Q(Mag_Charge)) vs. Shaft Axial Rotation Angle (β); for each rotating Magnetic Flywheel Induction Rotor;

FIG. 23: is a “System Design” view of Magnetic Flywheel Induction Engine-Motor-Generator, which incorporates wind and solar energy technologies, into a system that is “self-sustaining”, and depicted connecting the output of the apparatus, to a Charge Controller, which re-charges the battery, while simultaneously providing electrical and mechanical power output; is constructed of a “plurality” of adjacent Magnetic Flywheel Engine-Motor-Generators, Magnetic Flywheel Induction Rotors, Single/Dual Shafts Electrical Drive Motor, and DC/AC Electrical Motors/Generators/Alternators, and constructed into a closed system, is depicted in limited scope embodiment of the invention;

### DETAILED DESCRIPTION OF THE PREFERRED EMBODIMENTS

This “Discovery of Invention” patent, describes a more detailed description of preferred embodiments which include: the mechanical structure of the apparatus, working process, conceptual physics, and mathematics for the process of “Magnetic Induction”, utilized by the invention known herein as the “Magnetic Flywheel Induction Motor-Engine-Generator”.

The application of the law of “Magnetic Induction” as introduced in this patent is a new application of the laws of magnetism, predicting that two rotating “Permanent Magnet” bodies and their magnetic fields, interact with one another, such that when one “first” set of permanent magnets is set in motion, and rotates about an axis, separated by a fixed air gap distance from a “second” set of permanent magnets, set about an independent axis.

The rotary magnetic field of the “first” set of permanent magnets will induce rotation about the “second” set, permanent magnet body's axis of rotation. This induced magnetic energy generated by the apparatus is used to do mechanical work, rotating a mass load, about an axis.

The induced rotation of the “second” permanent magnet body is always in a direction with opposite spin and rotation, to that of the “first” permanent magnet's rotation and spin. The rotation of the second permanent magnet body is induced without any contact whatsoever, with the first rotating permanent magnet body; only an “air-gap distance” separates the two rotating permanent magnet bodies.

And thus, based on the universal physical law that every action produces an equal and opposite reaction; the rotation of the “second” permanent magnet body likewise induces a additional re-action motion, that is added to the initial “first” rotating permanent magnet body, which instigated the “magnetic induced” rotation of the second permanent magnet body.

Therefore the invention and the application of “Magnetic Induction” as demonstrated by the “Magnetic Flywheel Induction Motor-Engine-Generator” apparatus, is a magnetic mechanical process, in which energy is extracted from the interacting rotary magnetic fields of “permanent magnetic” systems, and from the vacuum of space-time. This induced magnetic energy generated by the apparatus is used to do mechanical work, rotating a mass load, about an axis.

This invention employs the new conceptual understanding and demonstration of the magnetic phenomena, and process of Magnetic Induction, which leads to the application of permanent magnetic motion; and may, however, be embodied in many different forms, which is not depicted herein.

The invention and apparatus as described in detail, and depicted in the accompanying drawings and figures, should not be construed as limited to the embodiments set forth herein. But, rather, these embodiments are provided so that this disclosure will be thorough and complete, and will fully convey the scope of the invention to those skilled in the art.

The invention will now be described more fully here-after with reference to the accompanying drawings, in which preferred embodiments of the invention are shown.

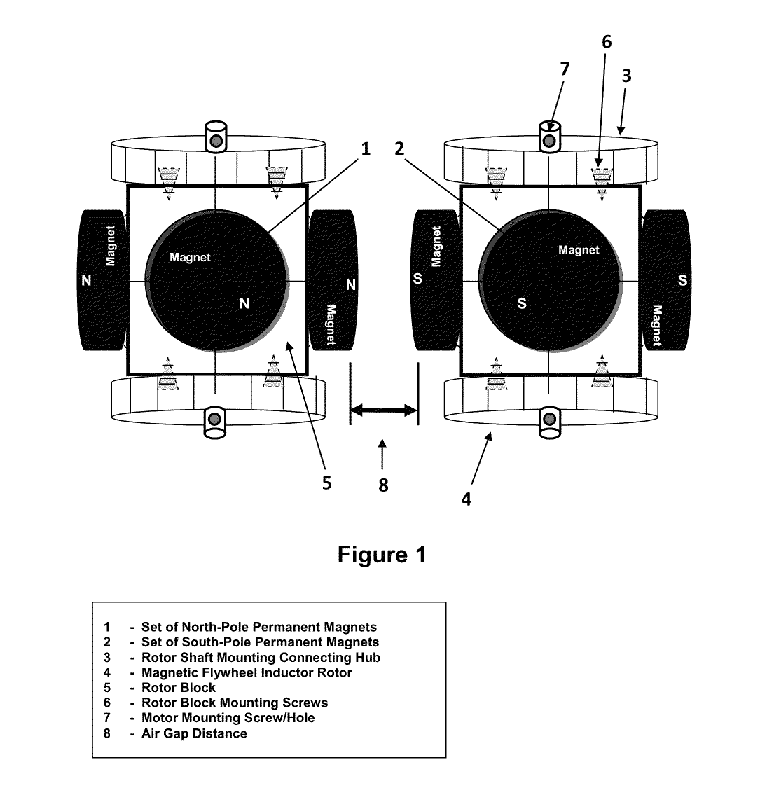

Referring initially to FIG. 1, top plan view; one embodiment in keeping with the teachings of the present invention is herein described, by way of example; an apparatus comprising two independent rotatable, “Magnetic Flywheel Induction Rotors” (4), separated by a an “Air Gap Distance” (8), that is greater than or equal to one half the diameter of one facet surface of the “Permanent Magnet” (1), (2) surface area.

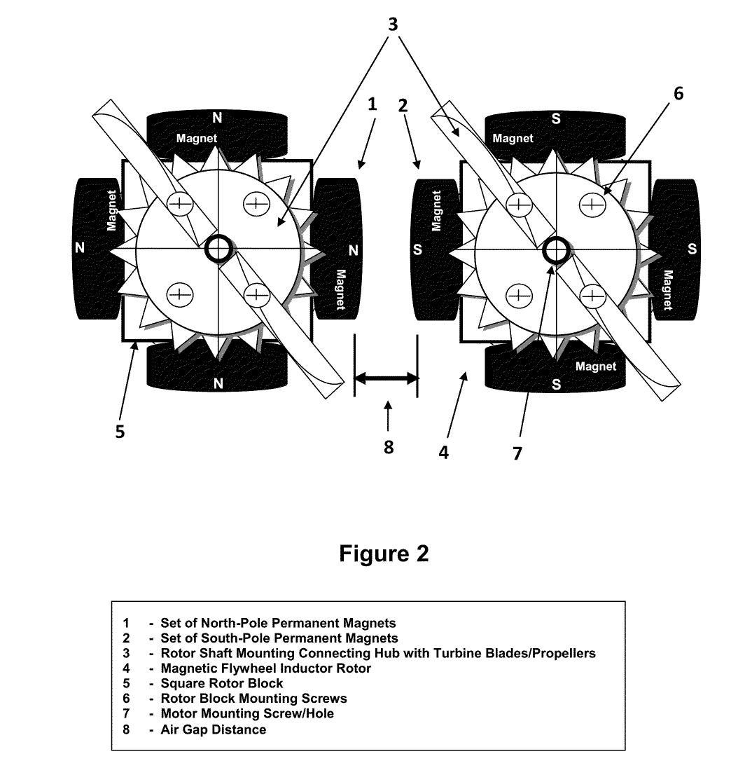

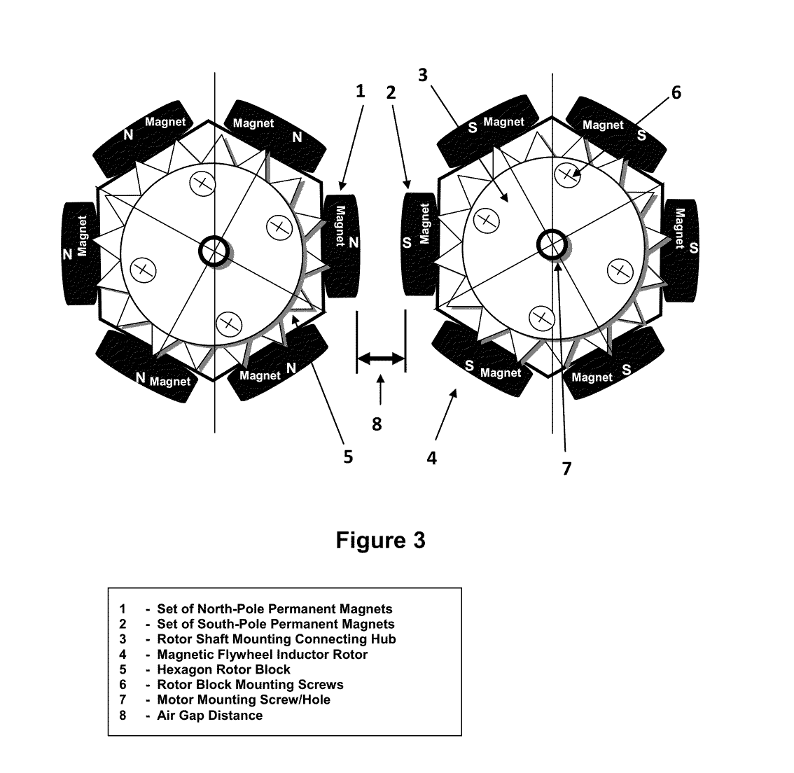

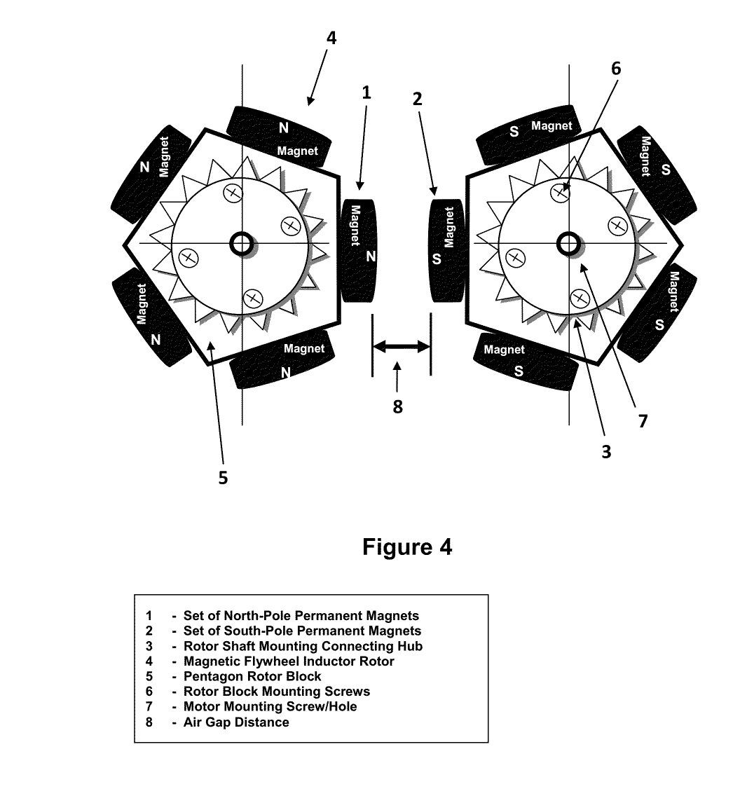

The apparatus according to FIG. 2, FIG. 3, and FIG. 4, left and right side views; depicts an apparatus comprising two independent rotatable, “Magnetic Flywheel Induction Rotors” (4), separated by a an “Air Gap Distance” (8), which are rotatable permanent magnet rotor block apparatus, which rotates about two independent motor shafts axis.

The apparatus according to FIG. 2, FIG. 3, and FIG. 4, left and right side views; claims the output efficiency of the apparatus, is based on a designated geometric “Rotor Block” (5) shape, characterized by a specific number of facet surfaces.

The greater the number of facets surfaces, associated with the rotor block shape, the faster the “Magnetic Flywheel Induction Rotors” (4) rotate, and the greater the output efficiency of the “Magnetic Flywheel Induction Motor-Engine-Generator”.

The apparatus according to FIG. 2, FIG. 3, and FIG. 4, left and right side views; depicts a single “Magnetic Flywheel Inductor Rotor” (4), described in limited scope, is constructed of three main components: a single “Rotor Block” (5), and two “Rotor Shaft Mounting Hubs” (3) on the left and right sides of the rotor, and a set of “Neodymium Permanent Magnets” (1), (2), attached to each facet surface and circumference, of the “Rotor Block” (5).

The apparatus according to FIG. 2, FIG. 3, and FIG. 4, left and right side views; depicts that a single “Magnetic Flywheel Induction Rotor” (4) reserves the left and right sides of the “Rotor Block” (5) for the “Rotor Shaft Mounting Connecting Hubs” (3); which connects or attaches various types of “Motors/Generators/Alternators” to the “Flywheel Rotor Blocks” (5).

Any “motor/generator/alternator” with an extended shaft can be connected and attached, to the “Magnetic Flywheel Induction Rotor Block” (5), via the “Rotor Shaft Mounting Connecting Hubs” (3).

The apparatus according to FIG. 2 left and right side views; depicts “Magnetic Flywheel Induction Rotors” (4) and “Magnetic Flywheel Induction Rotor Blocks” (5), with “Rotor Shaft Mounting Connecting Hubs” and Turbine Blades/Propeller” (3) attachments; used for cooling the “motors/generators/alternators”.

The apparatus according to FIG. 2, FIG. 3, and FIG. 4, left and right side views; makes the claims that any attachment that connects and joins a “motor/generator/alternator” with an extended shaft, to the “Magnetic Flywheel Inductor Rotor Block” (5), is considered a “Rotor Shaft Mounting Hub Connector” (3); and acts as a mechanical apparatus used for doing work which include the following attachments: Rotor, Gear, Pulley Wheel, Tire Rim, Fan/Blade Assembly, Propeller Assembly, Drive Wheel, and that which includes any rotating attachment, used for converting shaft rotational energy and motion, into mechanical work.

The apparatus according to FIG. 2, FIG. 3, and FIG. 4, left and right side views; depicts that a single “Magnetic Flywheel Inductor Rotor” (4), has a designated geometric “Rotor Block” (5) shape, and a minimum set of “Permanent Magnets” (1) per Flywheel “Rotor Block” (5): Triangle (three magnets), Square (four magnets), Pentagon (five magnets), Hexagon (six magnets), Octagon (eight magnets), Rectangle (four magnets), cylinder (four magnets), or Disk shaped Block (four magnets).

The greater the number of geometric facets or magnet surfaces per “Rotor Block” (5), the faster the “Magnetic Flywheel Induction Rotors” (4) rotate, and the greater the output efficiency of the “Magnetic Flywheel Induction Motor-Engine-Generator”.

The apparatus according to FIG. 2, FIG. 3, and FIG. 4, left and right side views; claims that a single “Magnetic Flywheel Inductor Rotor” (4), can be applied to any motor with a shaft, for the purpose of using the “rotational inertia” of the “Magnetic Flywheel Inductor Rotor” (4), to increase the rotational kinetic energy, applied to the shaft, and therefore improving the output efficiency of that motor; which may be embodied in many different forms, and should not be construed as limited to the embodiments set forth herein.

Rather, the embodiments of the “Magnetic Flywheel Inductor Rotor” (4) are provided so that this disclosure will be thorough and complete, and will fully convey the scope of the invention to those skilled in the art.

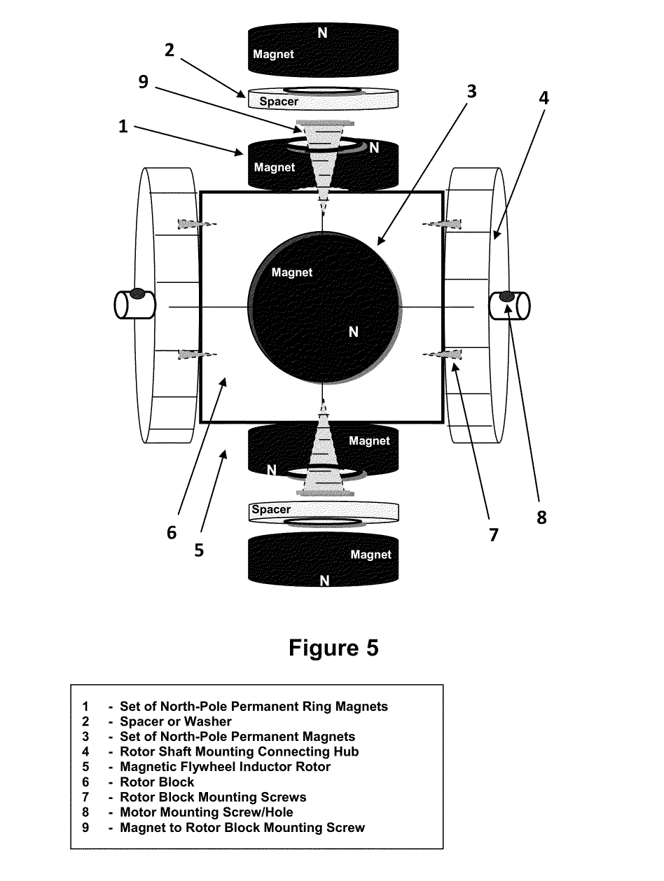

The apparatus according to FIG. 5, front and rear side views; depicts a single “Magnetic Flywheel Induction Rotor” (5) with a specific geometric “Rotor Block” (6) shape, which reserves the top, bottom, front, and rear, facet circumference sides, of the “Rotor Block” (6), for the arrangement and attachment of “Permanent Magnets” (1); with identical or like poles facing on the circumference, constructing a magnetic monopole apparatus.

The apparatus according to FIG. 5, front and rear side views; depicts that a single “Magnetic Flywheel Inductor Rotor” (5) is a “Magnetic Monopole” apparatus, and has either a complete north-pole facing or south-pole facing, arrangement of “Permanent Magnets” (1), (3), on the top, bottom, front, and rear, facet circumference sides, of the “Rotor Block” (6).

The apparatus according to FIG. 5, front and rear side views; depicts one type of method for attaching “Permanent Magnets” to a single “Magnetic Flywheel Inductor Rotor” (5) by using “Ring Magnets” which are then screwed into one of the facet surfaces of the “Rotor Block” (6). Other “Permanent Magnets” and “Spacers/Washers” are then stacked on top of the “Ring Magnets”, and affixed with various methods.

The apparatus according to FIG. 5, front and rear side views; claims that “Permanent Magnets” (1) which are Neodymium (Sintered Neodymium-Iron-Boron (NdFeB)), or “Rare Earth” are used for the greatest output efficiency of the apparatus. However ceramic permanent magnets, and other permanent magnet materials can also be used, but their output efficiencies are lower.

The mechanical attachment of the “Permanent Magnets” is depicted in limited scope, according to FIG. 5; and the various ways of attaching the “Permanent Magnets” (1) to the “Magnetic Flywheel Inductor Rotors” (5) can be embodied in many different forms, and should not be construed as limited to the embodiments set forth herein according to FIG. 5.

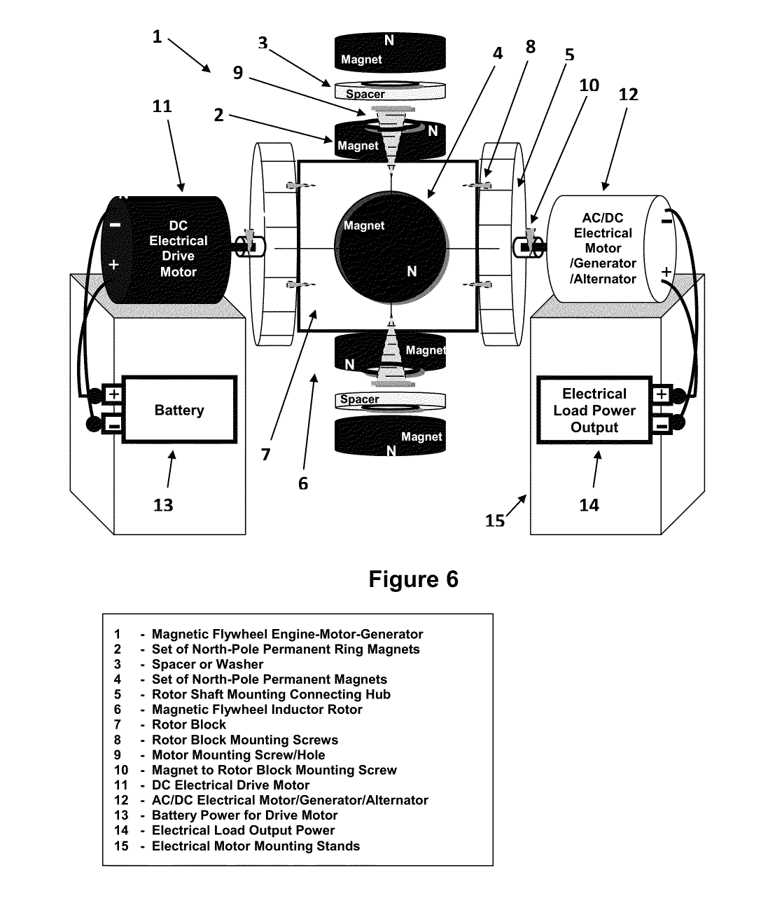

The apparatus according to FIG. 6, front and rear side views; depicts a “Magnetic Flywheel Engine-Motor-Generator” (1), used for the purpose of generating direct current (DC) electrical power, alternating current (AC) electrical power, and functions as a mechanical mover doing work, which includes: turning a rotor, gear, pulley, tire rim, fan, pumps, propeller/blades or drive wheel, propelling motor vehicles/aircraft/marine, etc.

The apparatus according to FIG. 6, front and rear side views; depicts in limited scope a “Magnetic Flywheel Engine-Motor-Generator” (1), constructed wherein any combination of two “Electrical Motors/Generators/Alternators” (11), (12), are mounted on separate bases, and positioned with shafts front facing oppositely (shafts facing shaft); and where each is joined together into a single apparatus, by a single “Magnetic Flywheel Inductor Rotor” (6).

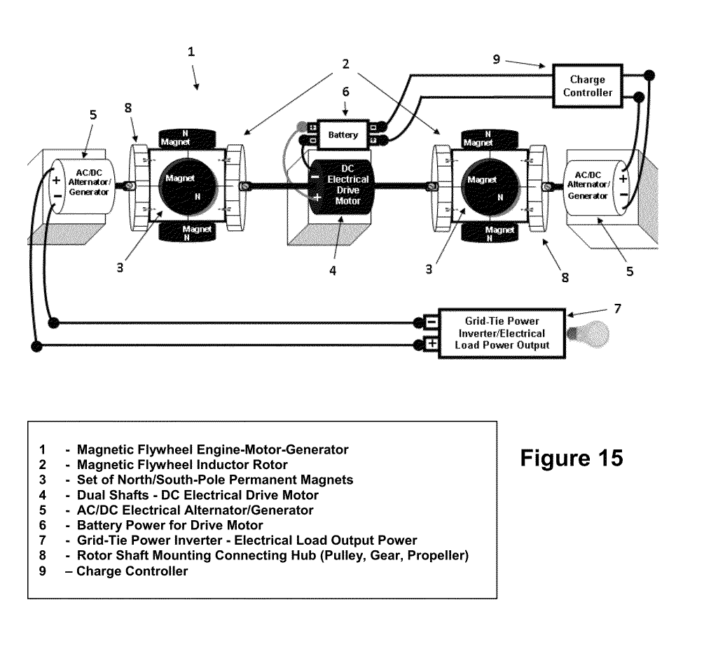

Likewise, the apparatus according to FIG. 15, front and rear side views; depicts the “Magnetic Flywheel Engine-Motor-Generator” (1), constructed to include “Dual Shafts—Electrical Drive Motors” (4); and where each motor shaft is joined or connected to a “Magnetic Flywheel Inductor Rotor” (2).

However, the apparatus according to FIG. 6, and FIG. 15, is not limited to electrical motors/generators/alternators, any prime mover including fossil fuel motors, fulfills identical purposes to electrical motors, described therein.

The apparatus according to FIG. 6, front and rear side views; depicts a “Magnetic Flywheel Engine-Motor-Generator” (1) constructed of: a minimum of one “Magnetic Flywheel Inductor Rotor” (6), one “Electric Drive Motor” (11) with an extended shaft, which includes dual shaft motors, and one “AC/DC Electrical Motor/Generator/Alternator” (12); mounted on separate bases (15), and positioned with shafts front facing oppositely (shafts facing shaft); and where each is joined together into a single apparatus, by a single “Magnetic Flywheel Inductor Rotor” (6).

When the three components described above are combined and constructed into a working apparatus, it is used for generating direct current (AC/DC) electrical power, charging batteries, charging electric vehicles, or acts as a mechanical mover doing work, which includes: turning a rotor, gear, pulley, tire rim, fan, or drive wheel, pumps, propellers, motors, propel vehicles, and various mechanical and electromechanically devices, not mentioned herein.

The apparatus according to FIG. 6, front and rear side views; depicts that when any one or more of the two “Electric Motors/Generators/Alternators” (11), (12), which constructs the “Magnetic Flywheel Engine-Motor-Generator” (1) is powered by a source such as a “Battery” (13), that motor is designated the “Drive Motor/s” (11). The remaining “Electric Motors/Generators/Alternators” (11), (12) function as a “DC/AC Electrical Power Generators”.

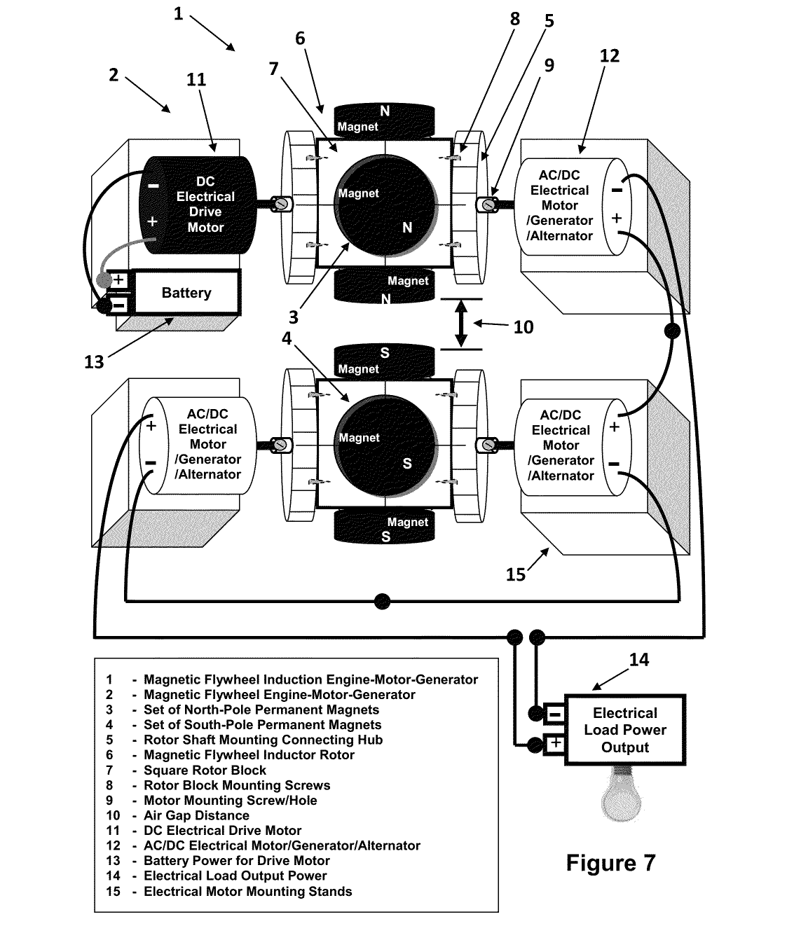

The apparatus according to FIG. 7, top plan view; depicts that the application of “Magnetic Induction” occurs when combining a plurality of two or more adjacently spaced “Magnetic Flywheel Engine-Motor-Generators” (2), separated with a small “Air Gap Distance” (8), between their respective “Permanent Magnets” (3), (4) surfaces; this constructs a magnetic induction apparatus known as a “Magnetic Flywheel Induction Engine-Motor-Generator” (1).

The apparatus according to FIG. 7, top plan view; depicted in limited scope a “Magnetic Flywheel Induction Engine-Motor-Generator” (1) which comprises a minimum of: four “Electric Motors/Generators/Alternators” (12), (13), which are positioned, combined/constructed where each motor shaft is joined to “Magnetic Flywheel Induction Rotors” (6); so as to function as an apparatus used for generating AC/DC electrical power, and for doing mechanical work.

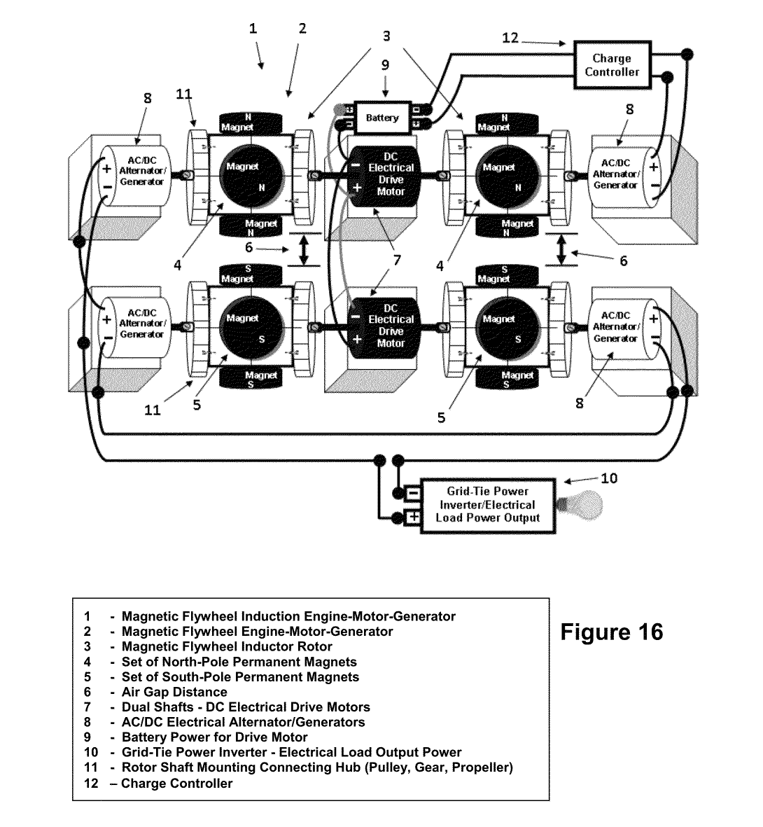

Likewise, the apparatus according to FIG. 16, top plan view; depicts the “Magnetic Flywheel Induction Engine-Motor-Generator” (1), constructed to include “Dual Shafts—Electrical Drive Motors” (7); and where each motor shaft is joined or connected to a “Magnetic Flywheel Inductor Rotor” (3).

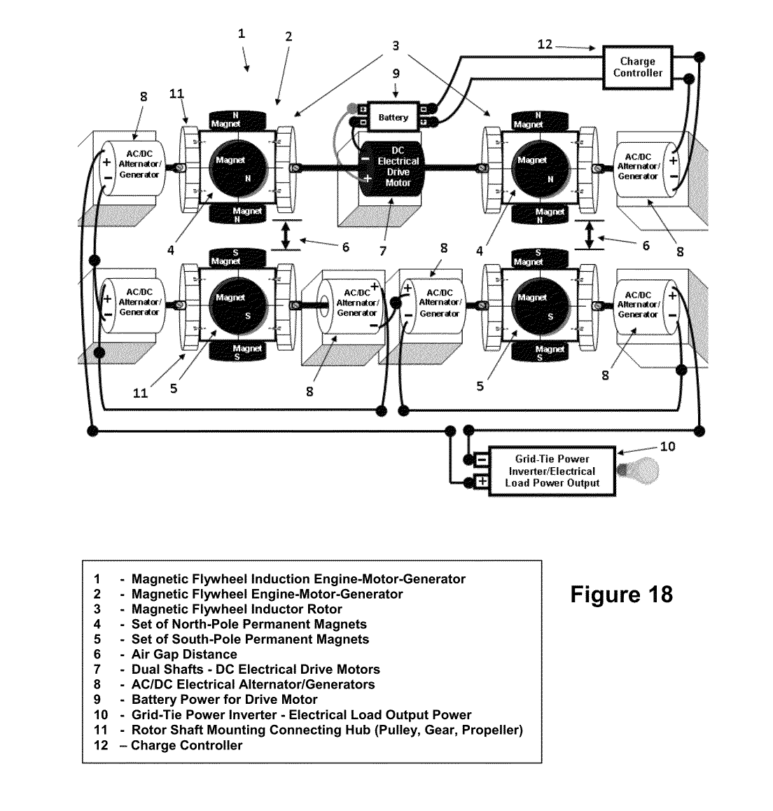

Furthermore, the apparatus according to FIG. 18, top plan view; depicts the “Magnetic Flywheel Induction Engine-Motor-Generator” (1), constructed to include “Dual Shafts—Electrical Drive Motors” (7); and where each motor shaft is joined or connected to a “Magnetic Flywheel Inductor Rotor” (3).

The apparatus according to FIG. 7, FIG. 16, and FIG. 18, top plan views; depicted in limited scope a “Magnetic Flywheel Induction Engine-Motor-Generator”, which functions when any one or more of the “Electric Motors/Generators/Alternators” is powered, it is designated the “Drive Motor”.

The remaining motors/generators/alternators and their respective motor shafts, attached to the rotating “Magnetic Flywheel Induction Rotors”, function as DC/AC power generators, and simultaneously as a mechanical mover doing work.

The AC/DC electrical power is extracted from the “AC/DC Electric Alternator/Generators”, attached to the “Magnetic Flywheel Induction Rotors”.

The “Pure” AC electrical power is extracted when various coils of magnetic wire, are positioned in various ways around, the rotatable “Flywheel Flywheel Induction Rotors”; “AC Electrical Power” will be generated in the coils of wire.

The mechanical work is extracted from the waste rotational energy, harvested from the mechanical rotational energy of the “Magnetic Flywheel Induction Rotors” and the “Rotor Shaft Mounting Hub Connector” (5) attachments which includes: rotor, gear, pulley, tire rim, fan, or drive wheel, pumps, propellers, motors, propel vehicles, and various mechanical and electromechanically devices, not mentioned herein which can be attached to the rotating “Magnetic Flywheel Induction Rotors”.

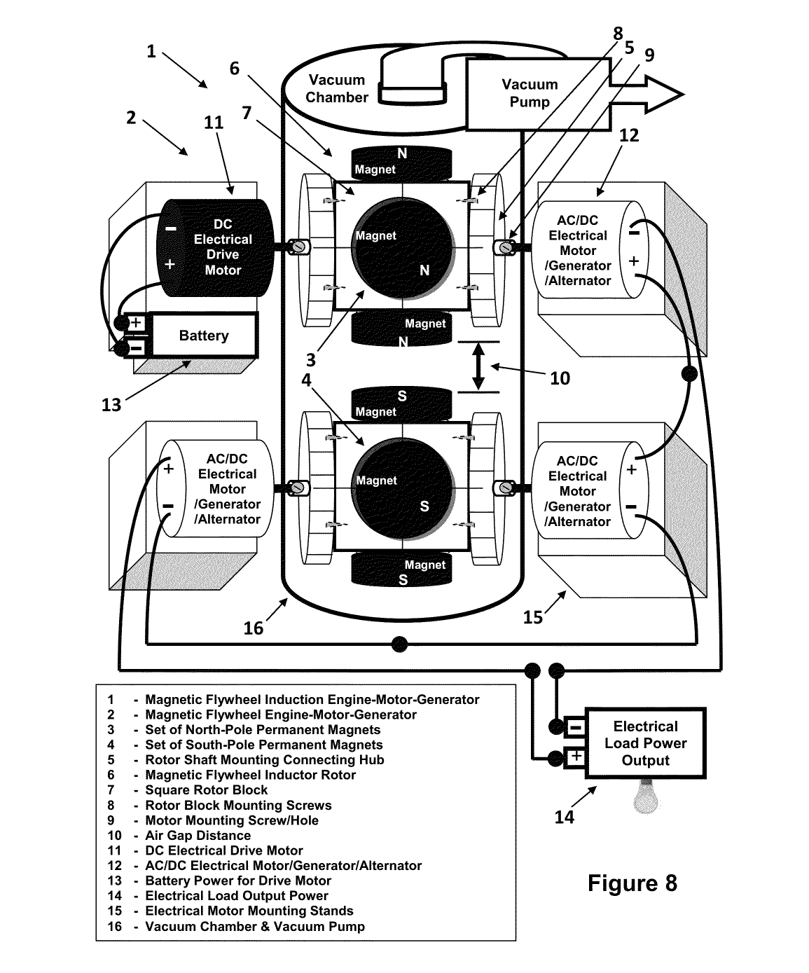

The apparatus according to FIG. 8, top plan view; depicts a single “Magnetic Flywheel Induction Engine-Motor-Generator” (1), and/or “Magnetic Flywheel Engine-Motor-Generator” (2) enclosed in an optional “Vacuum Chamber & Pump” (16) system, during normal operation, for improved output efficiency.

The apparatus according to FIG. 8, top plan view; further depicts, only the “Magnetic Flywheel Induction Rotors” (6) are enclosed within the “Vacuum Chamber & Pump” (16), all of the “Electric Motors/Generators/Alternators” (11), (12) with their extending motor shafts (including dual shafts motors), connected to the “Magnetic Flywheel Inductor Rotors” (6), remain outside of the “Vacuum Chamber & Pump” (16), during normal operation, for improved output efficiency.

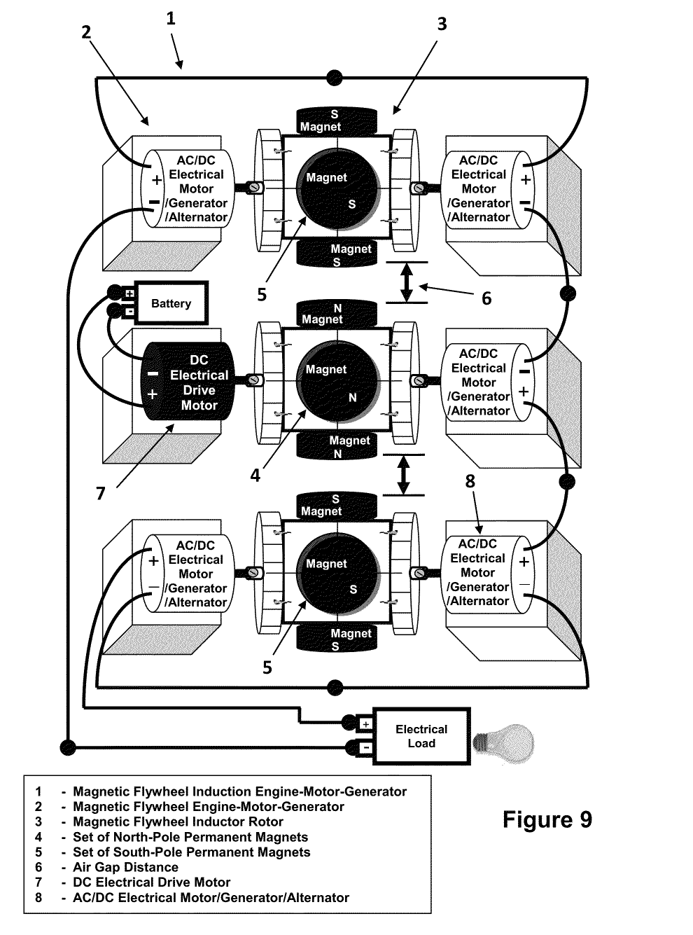

The apparatus according to FIG. 9 top plan view; further depicts that a “Magnetic Flywheel Induction Engine-Motor-Generator” (1) is constructed from a plurality of motors/generators/alternators, each joined to “Magnetic Flywheel Inductor Rotors” (3); thus any plural combination of a pair of adjacently spaced “Magnetic Flywheel Engine-Motor-Generators” (2); constructs the apparatus.

The apparatus is further depicted using a plurality of “Electrical Motors/Generators/Alternators” (11), (12), which are “not powered” functioning as DC/AC electrical power generators; and one or more “Electrical Motor/s” which are “powered”, and designated the “Drive Motor/s”, this is an apparatus known as a “Magnetic Flywheel Induction Engine-Motor-Generator” (1), as claimed invention therein.

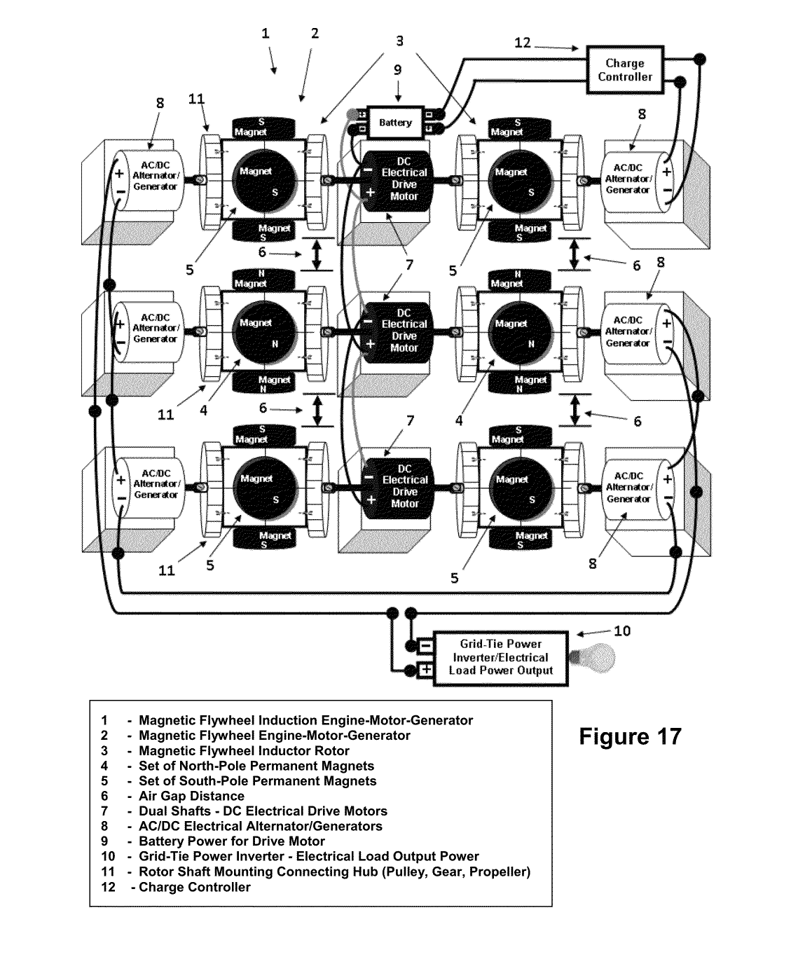

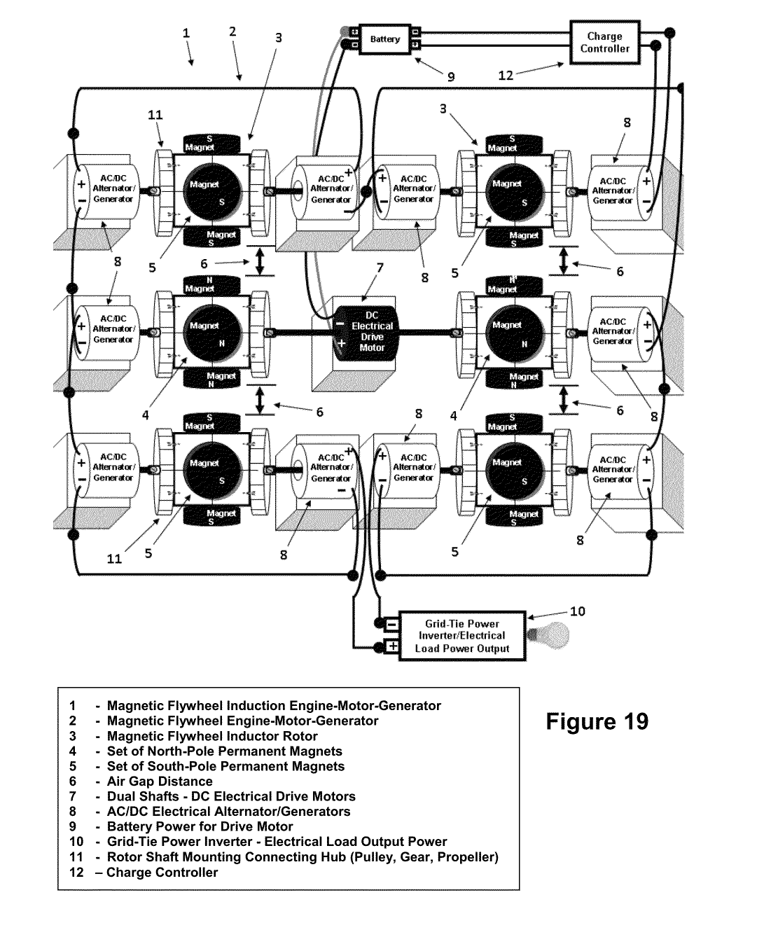

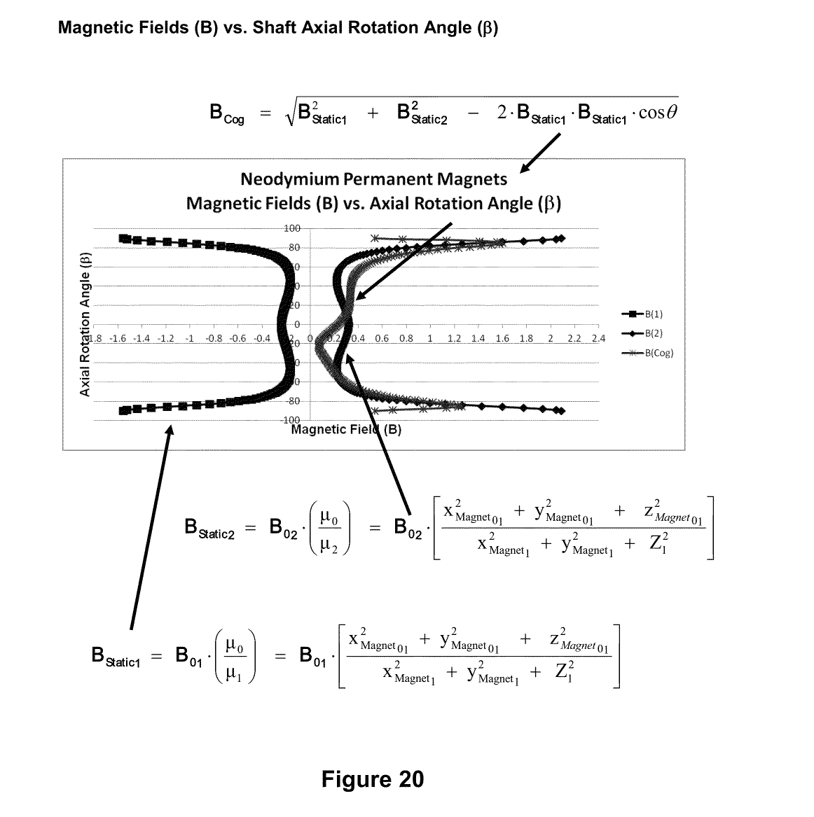

Likewise, the apparatus according to FIG. 17 and FIG. 19 top plan views; further depicts that a “Magnetic Flywheel Induction Engine-Motor-Generator” (1) is constructed from a plurality of “Dual Shaft Motors” (7), and “DC/AC Generators/Alternators” (8), each joined to “Magnetic Flywheel Inductor Rotors” (3); thus any plural combination of a pair of adjacently spaced “Magnetic Flywheel Engine-Motor-Generators” (2); constructs the apparatus.

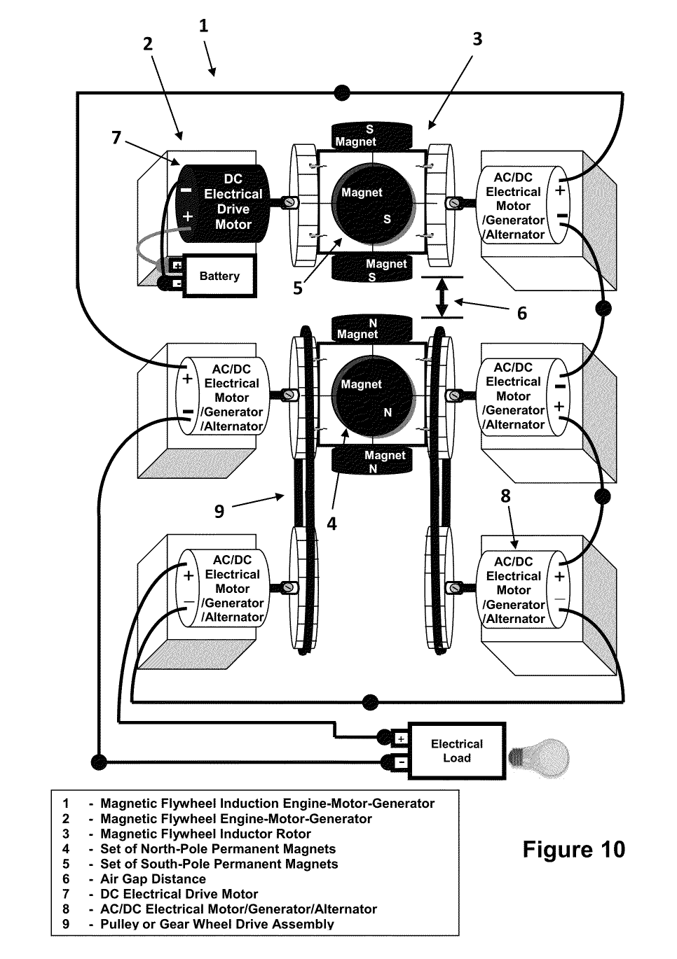

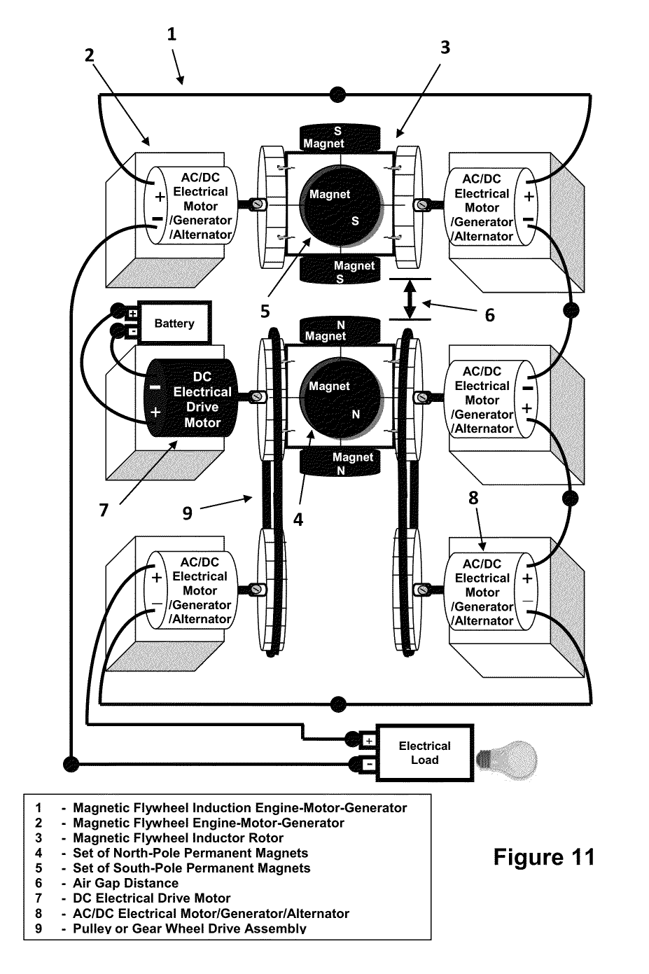

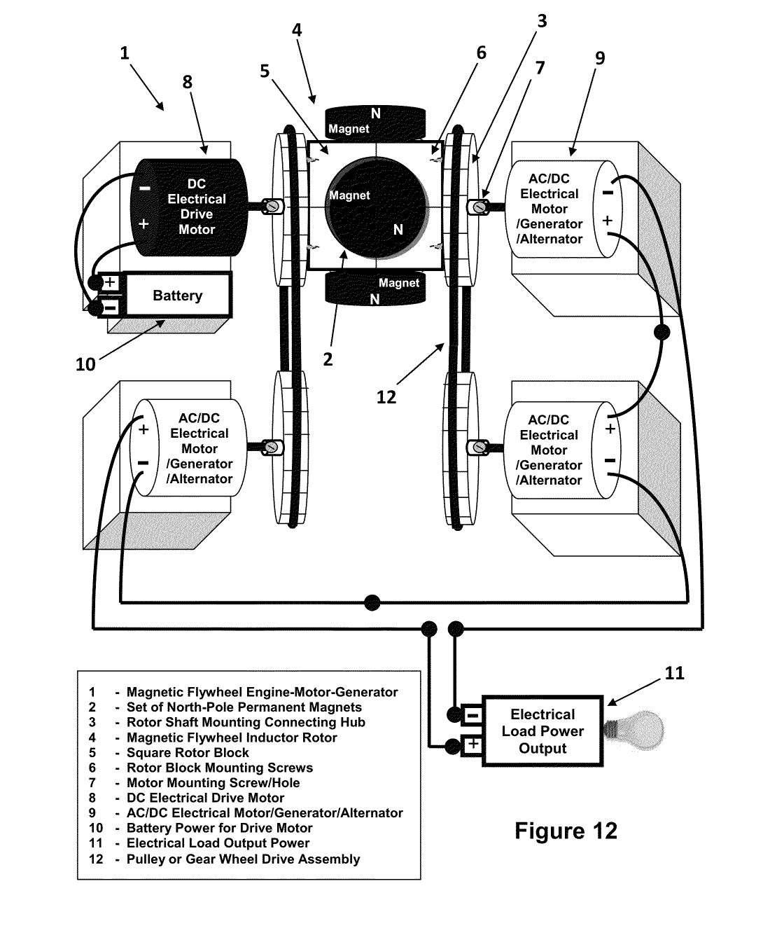

The apparatus according to FIG. 10, FIG. 11, and FIG. 12 top plan view; further depicts, using a “Magnetic Flywheel Induction Engine-Motor-Generator” (1), and the “Magnetic Flywheel Inductor Rotors” (3) (4) for the purpose of “Mechanical Work Output—Power Generation”, and employing various the “Rotor Shaft Mounting Connecting Hub” (3) attachments to the rotor block which include: Rotor, Gear, Pulley Wheel, Tire Rim, Fan Assembly, Propeller Assembly, Drive Wheel, etc, and any rotating attachment, used for converting shaft rotational energy and motion, into mechanical work.

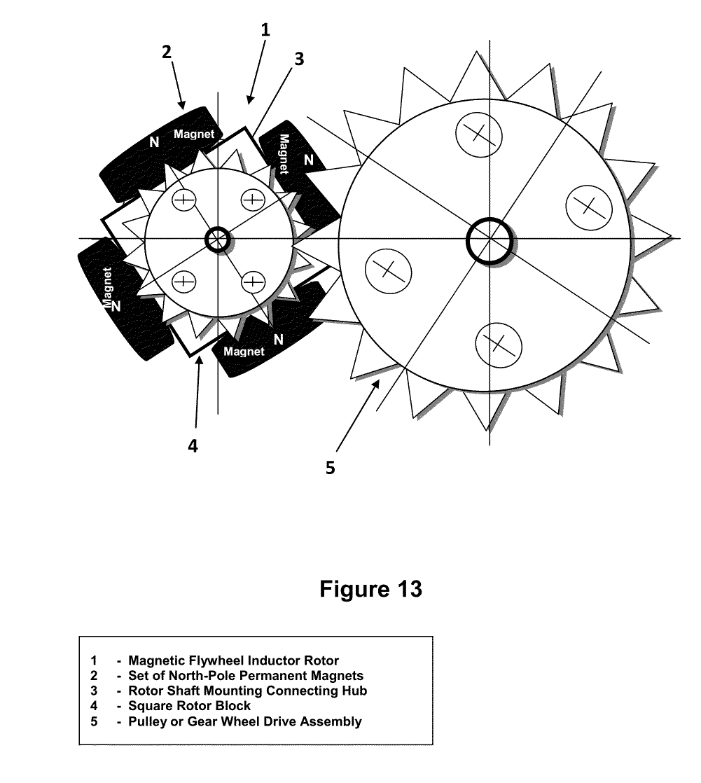

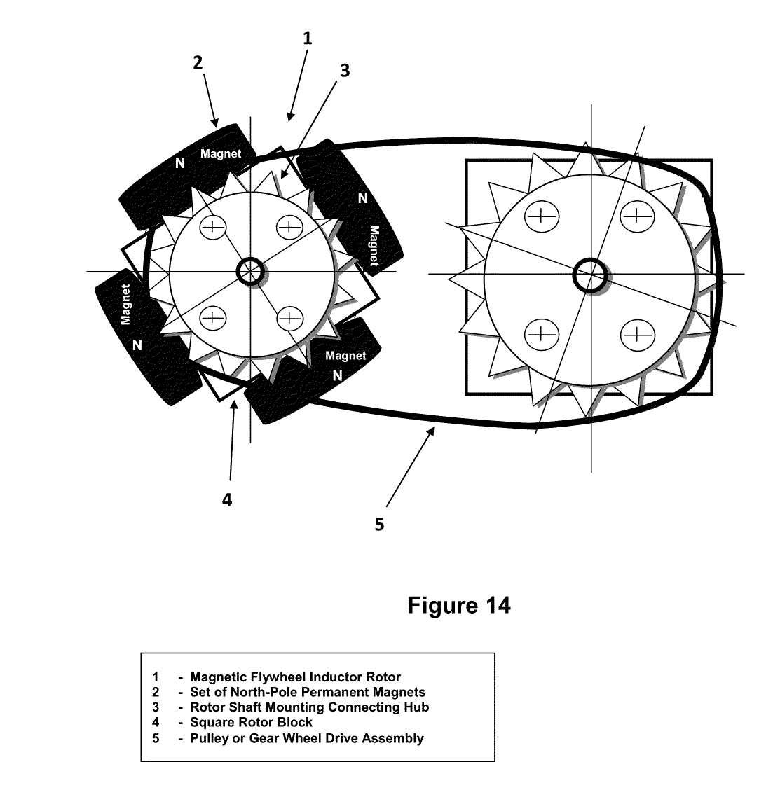

The apparatus according to FIG. 13, and FIG. 14 left and right side views; further depicts, using the “Magnetic Flywheel Inductor Rotors” (1) and the “Rotor Shaft Mounting Connecting Hub” (3) attachments for the purpose of “Mechanical Work Output—Power Generation”, which include: Rotor, Gear, Pulley Wheel, Tire Rim, Fan Assembly, Propeller Assembly, Drive Wheel, etc, and any rotating attachment, used for converting shaft rotational energy and motion, into mechanical work.

The invention depicted in FIG. 10, FIG. 11, FIG. 12, FIG. 13, and FIG. 14 depicts the mechanical work output application, using the “Magnetic Flywheel Inductor Rotors”, and the “Rotor Shaft Mounting Connecting Hubs” attachments for the purpose of “Mechanical Power Generation”, using various attachments for generating mechanical work, which may be embodied in many different forms, and should not be construed as limited to the embodiments set forth herein. Rather, the embodiments which depict the “Magnetic Flywheel Induction Engine-Motor-Generator” herein are provided so that this disclosure will be thorough and complete, and will fully convey the scope of the invention to those skilled in the art.

The invention and apparatus according to FIG. 15 & FIG. 16, top plan views; depicted in limited scope, a unique “Magnetic Induction” construction method, where a “Magnetic Flywheel Induction Engine-Motor-Generator” (1), is constructed with a minimum of two adjacent “Magnetic Flywheel Inductor Rotors” (3). Each “Magnetic Flywheel Inductor Rotor” (3) is connected to independent “DC/AC Electrical Motors/Generators/Alternators” (11), (12) motor shafts, and “Dual Shafts—Electrical Drive Motor/s” (7).

The invention and apparatus according to FIG. 15 & FIG. 16, top plan views; depicts that each “Magnetic Flywheel Inductor Rotors” (3), is “Magnetic Monopole” one with a “Permanent Magnet” (4) north-pole facing magnetic surface and circumference; which interacts with an adjacently spaced, “Magnetic Flywheel Inductor Rotors” (3), with a “Magnetic Monopole”, “Permanent Magnet” (5) south-pole facing magnetic surface.

An “Air Gap Distance” (6) separates the two “Magnetic Flywheel Inductor Rotors” (3), and their unlike magnetic monopoles surfaces. The “Air Gap Distance” (6), is a minimum distance of one half the diameter of the “Permanent Magnet” (4), (5) surface, or rotor block surface, so long as not to impede the rotational motion of the “Magnetic Flywheel Inductor Rotors” (3).

If the apparatus is constructed such that the magnetic field strength, which emanates from the Permanent Magnet's″ (4), (5) north/south pole facing magnetic surfaces is very strong, such that the two independent magnetic fields interact, within the minimum “Air Gap Distance” (6), space, between the two magnetic surfaces, then more torque is required by the “Electrical Drive Motor/s” (7), to initiate “magnetic induction” and rotational motion of the “Magnetic Flywheel Inductor Rotors” (3); and once rotating, the greater the output efficiency of the “Magnetic Flywheel Induction Engine-Motor-Generator” (1).

The invention and apparatus according to FIG. 15 & FIG. 16, top plan views; makes further claims in depiction for a unique “Magnetic Induction” construction method and process; where any two or more adjacent “Magnetic Monopole” “Magnetic Flywheel Inductor Rotors” (3), which are rotatable about motor shaft axis, create “Rotary Magnetic Fields”, which induce mechanical rotational motion into adjacent permanent magnet and electromagnetic bodies/systems, as they rotate, about their respective motor shafts axis.

Separating the “Magnetic Flywheel Inductor Rotors” (3) from one another, is the vacuum of space, and two or more “Permanent Magnet” (4), (5) unlike pole faces, each magnetic surface separated by a fixed “Air Gap Distance” (6). The air gap distance, is a minimum distance of one half the diameter of the “Permanent Magnet” (4), (5) surface, or rotor block surface, so long as not to impede the rotational motion of the “Magnetic Flywheel Inductor Rotors” (3).

The invention and apparatus according to FIG. 15 & FIG. 16, top plan views; depicts that when one or more of the “Drive Motor/s” (7) is “powered”, it starts the “first set” of “Magnetic Flywheel Inductor Rotor/s” (3) rotating about their motor shafts axis, and thereby creates a “Rotary Magnetic Field”, relative to a “second set” of “unpowered” “Magnetic Flywheel Inductor Rotor/s” (3).

The direction of rotation of the “second set” of “unpowered” “Magnetic Flywheel Inductor Rotor/s” (3), rotates in a direction that is opposite, to the rotation, of the “first set” of “Magnetic Flywheel Inductor Rotor/s” (3), which initially induced the rotational motion.

In the “Air Gap Distance” (6) space, if the “Rotary Magnetic Fields” of the “Magnetic Flywheel Inductor Rotor/s” (3), and their “Permanent Magnet” (4), (5) unlike pole faces are “equal” in magnetic strength, magnetic induction occurs so that the two “Magnetic Flywheel Inductor Rotor/s” (3), rotate about their respective motor shaft axis with “equal” and opposite rotational motion quantities: angular velocity, revolutions per minute (RPM), tangential velocity, and torque values.

In the “Air Gap Distance” (6) space, if the “Rotary Magnetic Fields” of the “Magnetic Flywheel Inductor Rotor/s” (3), and their “Permanent Magnet” (4), (5) unlike pole faces are “not equal” in magnetic strength, magnetic induction occurs so that the two “Magnetic Flywheel Inductor Rotor/s” (3), rotate about their respective motor shaft axis with “un-equal” and opposite rotational motion quantities: angular velocity, revolutions per minute (RPM), tangential velocity, and torque values.

The above claim for the invention and application of “Magnetic Induction” physics, describes a construction method and process for providing mechanical advantage to the output, of apparatus; such that whenever two or more “Magnetic Flywheel Inductor Rotors” (3), interacting, with equal or different magnetic strength values, their static and rotary magnetic fields, functions like a mechanical gear ratio.

Which when utilized, in the skilled arts of declared invention, provides a mechanical advantage to the output efficiency, of the “Magnetic Flywheel Induction Engine-Motor-Generator” (1).

The invention and apparatus according to FIG. 15, FIG. 16, FIG. 17, FIG. 18, and FIG. 19, top plan views; depicts a “Magnetic Flywheel Induction Engine-Motor-Generator” (1), in conjunction with the “Electrical Drive Motor/s” (7), “AC/DC Electrical Alternator/Generators” (8), and the rotatable “Flywheel Induction Rotors” (6), is used as an apparatus to recharge various types of “Rechargeable Batteries” (13), while simultaneously generating DC/AC Electrical output power, for powering electrical loads, propelling vehicles/aircraft/marine, and or producing mechanical work.

The apparatus according to FIG. 15, FIG. 16, FIG. 17, FIG. 18, and FIG. 19, top plan views; not depicted in drawings, a “Magnetic Flywheel Induction Engine-Motor-Generator” (1), functions as an “Pure—AC Electrical Power Generator” when various coils of magnetic wire, are positioned in various ways around, the rotatable “Flywheel Induction Rotors” (3), and their rotary magnetic fields that they generate; “Pure—AC Electrical Power” will be generated in the coils of wire.

The apparatus according to FIG. 15, FIG. 16, FIG. 17, FIG. 18, and FIG. 19, makes the claims that the electrical power inputs, which connects the wiring to the “Drive Motor/s” (7), and the electrical power outputs, which connects the wiring from the “Electrical Motors/Generators/Alternators” (8), can be connected into various “Series” or “Parallel” wiring configurations; based on the input and output power requirements of the system.

Thus, the wiring of the inputs and outputs making the electrical power connects to the various components of the apparatus depicted in drawings, may be embodied in many different forms, and should not be construed as limited to the embodiments set forth herein.

The invention according to FIG. 19, herein depicts a mathematical graph, which presents new ferromagnetic physics, and a unique “Magnetic Induction”, method for calculating the “Magnetic Field (B)” and the “Faraday/Lorentz Induction Force” acting on a rotating permanent magnet body, in the surrounding medium space, of a separate and independent, static or rotary magnetic field.

The invention according to FIG. 20, the invention herein depicts a mathematical graph, which presents new ferromagnetic physics, and a unique “Magnetic Induction” method for calculating the value of “Magnetic Permeability” and “Relative Permeability” on the surface, and in the surrounding medium space, of a single permanent magnet body, and two (2) permanent magnet bodies in interaction.

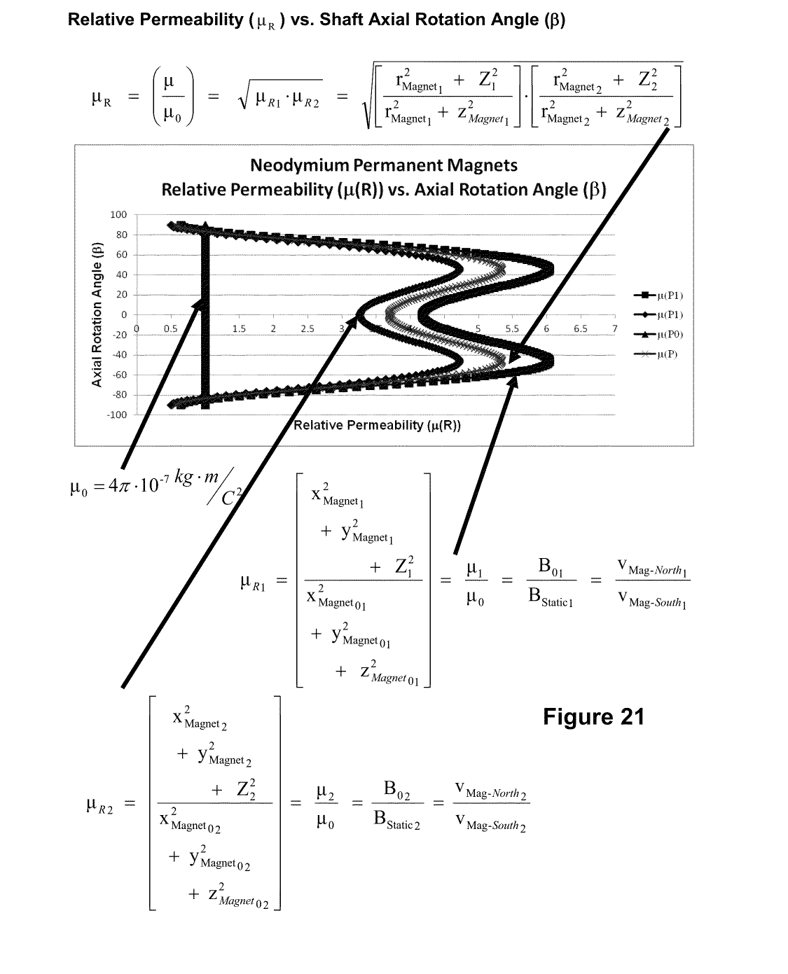

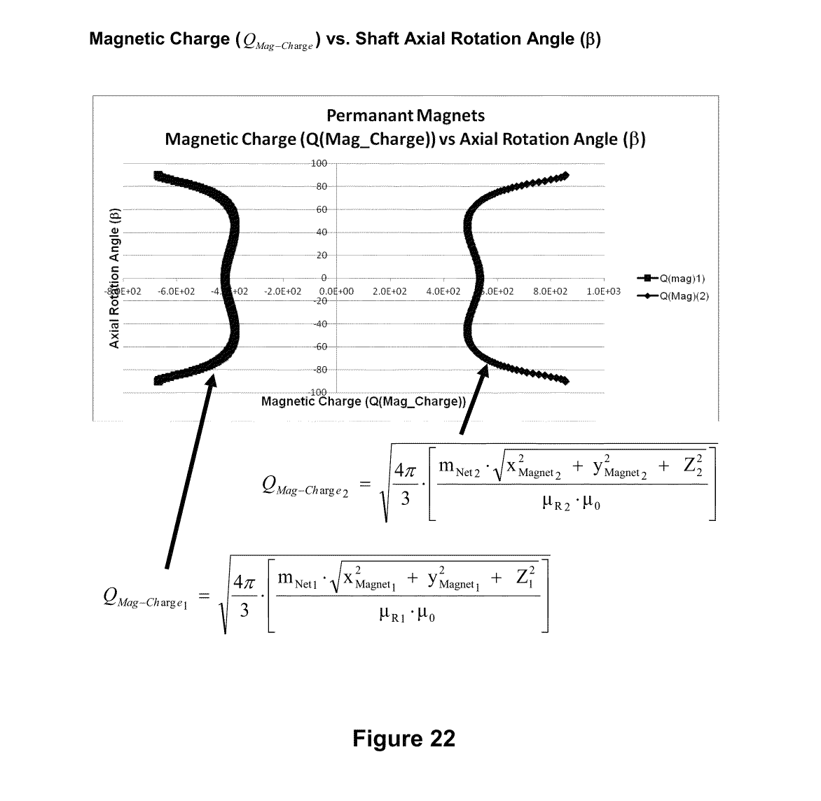

The invention according to FIG. 21, the invention herein depicts a mathematical graph, which presents new ferromagnetic physics, and a unique “Magnetic Induction” method for calculating the value of “Magnetic Charge” on the surface, and in the surrounding medium space, of a permanent magnet body.

The “Magnetic Charge” as measured using invention, is found being associated with the “electrified bodies” found in magnetism, electromagnets, and permanent magnets.

The “Magnetic Charge” manifest differently from the “Electric Charge”. The “Electric Charge” is found being associated with the “electrified bodies” found in electricity, current carrying conducting wires, and coils.

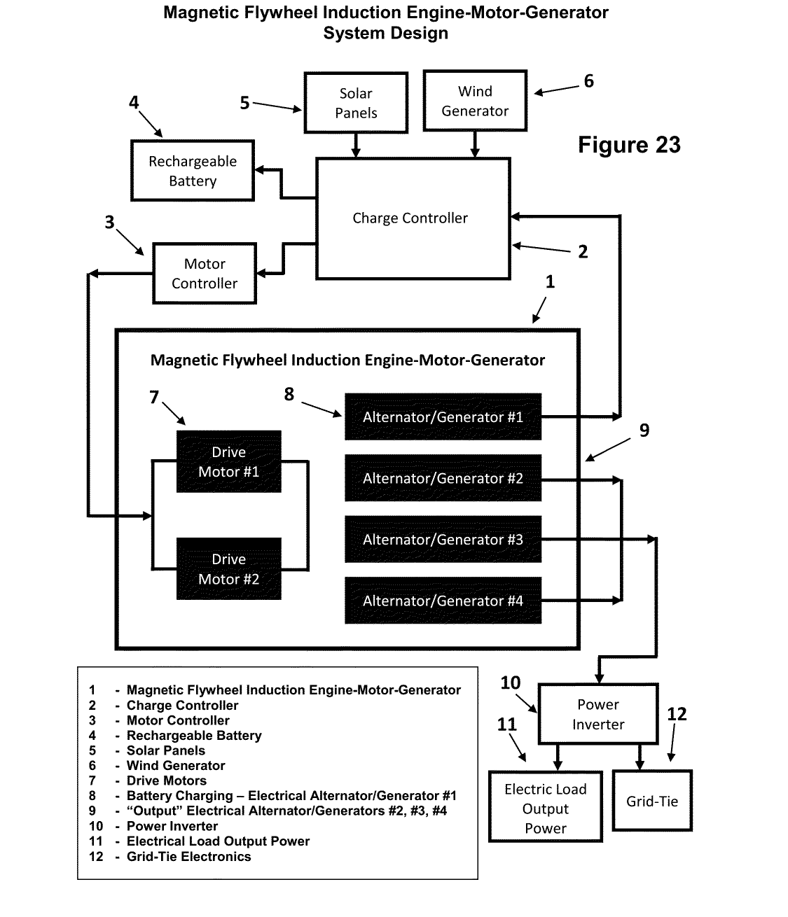

The invention according to FIG. 23, depicts in limited scope a “System Design” utilizing the “Magnetic Flywheel Induction Engine-Motor-Generator” (1), which acts as a contributor to the green energy technology mix, which includes wind energy and solar energy technologies.

The invention according to FIG. 23, depicts in limited scope a “System Design” utilizing the “Magnetic Flywheel Induction Engine-Motor-Generator” (1), as an apparatus to recharge various types of “Rechargeable Batteries” (4), while simultaneously generating DC/AC Electrical output power, for powering electrical loads, propelling vehicles/aircraft/marine, and or producing mechanical work.

The invention according to FIG. 15, FIG. 16, FIG. 17, FIG. 18, and FIG. 19, likewise depicts in limited scope a “System Design” utilizing the “Magnetic Flywheel Induction Engine-Motor-Generator” (1).

The invention according to FIG. 23, depicts in limited scope a “System Design”, further describes that when combing a “Charge Controller” (2) in conjunction with a “Rechargeable Battery” (4) source, connected to the output of the “Magnetic Flywheel Induction Engine-Motor-Generator” (1), acts “self-sustaining”; by connecting the electrical output, from one or more of the “DC/AC Electrical Motors/Generators/Alternators” (8), to the a “Charge Controller” (2), or directly to the “Rechargeable Battery” (4) source.

The above “self-sustaining” design is very similar the electrical battery charging system in an automobile/car; where the car's alternator, is connected to the turning engine, and the battery. And as long as the car's engine is turning, the alternator is generating electricity, and recharges the battery.

The invention according to FIG. 23, further describes that “self-sustaining” is accomplished, when “input” power into the “Charge Controller” (2) or the “Rechargeable Battery” (4), is from the “output” power of one or more, of the “DC/AC Electrical Motors/Generators/Alternator/s” (8).

The “self-sustaining” is further accomplished, when the “output” power from the “Charge Controller” (2) or the “Rechargeable Battery” (4) source, is fed back as “input” via the “Motor Controller” (3) and/or “Drive Motors” (7), of the “Magnetic Flywheel Induction Engine-Motor-Generator” (1).

The “Magnetic Flywheel Induction Engine-Motor-Generator's” (1), remaining “DC/AC Electrical Motors/Generators/Alternators” (9), outputs are configured into “Series” or “Parallel” wiring configurations, and connected to a “Power Inverter” (10) or “Grid-Tie Inverter” (12); which is furthered utilized for the powering of “Electrical Loads” (11), electronics and appliances. Furthermore, the “Power Inverter” (10), when connected to a “Grid-Tie Inverter” (12), is furthered utilized for sending power back to the mains power grid.

The various uses for the power outputs from the “Magnetic Flywheel Induction Engine-Motor-Generator” (1) include: powering electronic/appliances, homes/campers/buildings, propelling vehicles/aircraft/marine, charging-powering electric vehicles, off Mains Grid systems, and when combined with wind energy and solar energy, becomes a sea of new emerging technologies.

The invention described in application “Magnetic Flywheel Induction Engine-Motor-Generator”, may be embodied with a plurality of “motors/generators/alternators”, “Magnetic Flywheel Induction Rotors”, and “Rotor Shaft Mounting Hubs” attachments, in many different forms, and should not be construed as limited to the embodiments set forth herein.

Rather, the embodiments of the “Magnetic Flywheel Induction Engine-Motor-Generator” are provided so that this disclosure will be thorough and complete, and will fully convey the scope of the invention to those skilled in the art.

Applicant has described preferred embodiments of this invention, in very general depictions and descriptions, it will be understood that the broadest scope of this invention includes modifications such as diverse shapes, sizes, and materials.

Such scope is limited only by the claims as read in connection with the specification. Further, many other advantages of applicant's invention will be apparent to those skilled in the art from the descriptions and the claims described therein.

That which is claimed is:

1. The apparatus makes the claim of invention known as a “Magnetic Flywheel Engine-Motor-Generator”, described in limited scope is constructed: a minimum of one (1) “Magnetic Flywheel Inductor Rotor”, one (1) “Prime-Mover” motor with extended shafts, and one (1) “Alternator/Generator”, mounted on separate bases, and positioned with shafts front facing oppositely (shafts facing shaft), which includes dual shaft motors; when combined as an apparatus, is used for generating direct current (DC) electrical power, alternating current (AC) electrical power, or acts as a mechanical mover doing work, which includes: turning a rotor, gear, pulley, tire rim, fan, or drive wheel, pumps, propellers, propelling vehicles/aircraft/marine, and various mechanical and electromechanically devices, not mentioned herein.

2. The apparatus according to claim 1, further claims, when any minimum of one (1) or more “prime movers” is an “Electric Motor/Generator” which is powered, it is designated a “Drive Motor”, and the others unpowered DC/AC Generators/Alternators, attached to rotating “Magnetic Flywheel Inductor Rotors”, typically function as a “DC Electrical Power Generator” or an “AC Electrical Power Generator”, which supplies power, used to recharge batteries, and power various electronics, appliances, electric vehicles, motors, and supply power back to a mains power grid.

3. The apparatus according to claim 1, and claim 2, further claims, when all “Electric Motor/Generators” are powered, they are all designated “Drive Motors”; and the “Magnetic Flywheel Engine-Motor-Generator” apparatus, functions as a mechanical mover doing work, which includes: turning a rotor, gear, pulley, tire rim, fan, or drive wheel, pumps, motors, propelling vehicles/aircraft/marine, and various mechanical and electromechanically devices, not mentioned herein.

4. The apparatus makes further claims extending the depth of invention according to claim 1, for combining a plurality of two (2) or more adjacently spaced “Magnetic Flywheel Engine-Motor-Generators”, separated with a small “Air Gap” distance, between their respective “Magnetic Flywheel Inductor Rotor” permanent magnets surfaces; this constructs a different apparatus as described herein, known as a “Magnetic Flywheel Induction Engine-Motor-Generator” constructed of: a minimum of two (2) “Magnetic Flywheel Inductor Rotors”, two (2) “Prime-Mover” motors with extended shafts (including dual shafts), two (2) “Alternator/Generators”, and an “Air Gap Distance” separating the “Magnetic Flywheel Inductor Rotor” permanent magnets surfaces.

5. The apparatus makes claims, according to claim 4, a “Magnetic Flywheel Induction Engine-Motor-Generator” uses the new physics of “magnetic induction”, harvesting waste rotational mechanical energy, collected in the “Rotary Magnetic Fields” of the “Magnetic Flywheel Induction Rotors”, lost by the “Drive Motor/s”, used to power and mechanically drive the rotation of “Magnetic Flywheel Induction Rotors” about their respective axis of the motor shafts; and when attached to “Electrical Alternator/Generators” is used for generating direct current (DC) electrical power, alternating current (AC) electrical power, or acts as a mechanical mover doing work, which includes: turning a rotor, gear, pulley, tire rim, fan, or drive wheel, pumps, propellers, motors, propelling vehicles/aircraft/marine, and various mechanical and electromechanically devices, not mentioned herein.

6. The apparatus according to claim 4, further claims, when limiting the invention described herein to two (2) “Magnetic Flywheel Induction Rotors”, two (2) “prime-mover” “Dual Shafts Electrical Motor/Generators”, and four (4) “DC/AC Alternator/Generators”, and when any one (1) or both “prime-mover” “Electrical “Drive” Motor/Generators” is powered, wherein the four (4) “DC/AC Alternator/Generators” are not powered, but is attached via motor shafts and connecting hubs, to each of the four (4) “Magnetic Flywheel Induction Rotors”, the apparatus functions as “DC/AC Electrical Power Generator”, where the power is supplied by the “DC/AC Alternator/Generators”.

7. The apparatus according to claim 1, claim 4, and claim 6, further claims, for the purpose of increasing the AC/DC electrical power output of invented apparatus, and or mechanical work output, is accomplished by attaching any plural pair of adjacently spaced “Magnetic Flywheel Engine-Motor-Generators”, each aligned and stacked together, separated by an “Air Gap Distance” between their respective “Magnetic Flywheel Inductor Rotors” permanent magnets surfaces; this is also an apparatus known as a “Magnetic Flywheel Induction Engine-Motor-Generator”, as claimed therein.

8. The apparatus according to claim 1, claim 4, claim 6, and claim 7, makes further claims, for greatly increasing the output efficiency, of a “Magnetic Flywheel Induction Engine-Motor-Generator”, by housing and enclosing the “Magnetic Flywheel Inductor Rotors”, in an optional vacuum chamber, during normal operation; and where all of the “Electric Motors/Alternators/Generators” with their extending motor shafts, connected to the “Magnetic Flywheel Inductor Rotors”, remain outside of the vacuum chamber, for greatly improved output efficiency of the apparatus.

9. The apparatus makes claims, according to claim 1, claim 4, claim 6, and claim 7, the “Magnetic Flywheel Induction Engine-Motor-Generator”, and its construction are not limited to “Electrical Motor/Generators/Alternators” only; but any “Prime-Mover”, including fossil fuel engines, with a motor shaft, could be used as “Drive Motors” to power the apparatus.

10. The apparatus according to invention, makes further claims, a single “Magnetic Flywheel Induction Rotor”, is a “Magnetic Monopole”, rotatable permanent magnet rotor block apparatus, which rotates about motor shafts axis; and where greater values in output efficiency of the apparatus, are based on a designated geometric “Rotor Block” shape, specific number of facet surfaces of block, total mass/inertia of rotor block, and the magnetic strength on the facets surfaces.

11. The apparatus according to claim 10, a single “Magnetic Flywheel Induction Rotor” is “Magnetic Monopole”, constructed of three main components: a single “Rotor Block”, and two (2) “Rotor Shaft Mounting Hub Connectors” attached on the left and right sides of the rotor block, and a set of Neodymium Permanent Magnets, with identical magnetic pole strength, attached to each facet surface, and circumference of the “Magnetic Flywheel Induction Rotor” block.

12. The apparatus according to claim 10 and claim 11, a single “Magnetic Flywheel Induction Rotor Block” has a designated geometric rotor block shape, and number of facets side surfaces on the circumference of rotor block, which determine the output efficiency of the engine-motor-generator; where more facets surfaces, equals greater efficiency in rotation output: Triangle (5 five sides), Square (6 six sides), Pentagon (7 seven sides), Hexagon (8 eight sides), Octagon (10 ten sides), Rectangle (6 six sides), cylinder (3 three sides), or Disk shaped Block (3 three sides).

13. The apparatus according to claim 1, claim 4, claim 6, and claim 10, further claims, any “prime-mover” or “Motor/Generators/Alternators” with an extended motor shaft, can be connected to the “Magnetic Flywheel Induction Rotor Block”, via the “Rotor Shaft Mounting Hubs”, attached to the left and right sides of the “Flywheel Rotor Block”; and is an apparatus which connects various types of “Motor/Generators/Alternators” in different configurations to the “Magnetic Flywheel Induction Rotor Blocks”.

14. The apparatus according to claim 11, further claims, any attachment that connects and joins a “prime-mover” or “Motor/Generators/Alternators” with an extended shaft, to the “Magnetic Flywheel Inductor Rotor Block”, is considered a “Motor Shaft Mounting Hub Connector”; and is also considered: Rotor, Gear, Pulley Wheel, Tire Rim, Fan/Blade Assembly, Propeller Assembly, or Drive Wheel, which includes any rotating attachment, used for converting shaft rotational energy and motion, into mechanical work.

15. The apparatus according to claim 10 and claim 11, which further claims, a single “Monopole” “Magnetic Flywheel Induction Rotor” with a specific geometric Rotor Block shape, reserves the top, bottom, front, and rear, facet circumference surface sides, of the “Flywheel Rotor Block”, for the arrangement and attachment of “Permanent Magnets”; with identical magnetic “north poles” or “south poles” facing on the facet surface circumference, of a single “Monopole” “Magnetic Flywheel Induction Rotor”.

16. The apparatus according to claim 10, claim 11, and claim 15, further claims, a single “Monopole” “Magnetic Flywheel Inductor Rotor Block” has attached permanent magnets that are Neodymium (Sintered Neodymium-Iron-Boron (NdFeB)), for the greatest output efficiency of the apparatus. However ceramic permanent magnets, and other permanent magnet materials can also be used, but their rotational motion output efficiencies are lower.

17. The apparatus according to claim 10, claim 11, claim 15, and claim 16, a single “Monopole” “Magnetic Flywheel Inductor Rotor Block” has a designated rotor block shape, and a minimum set of permanent magnet surfaces, per Flywheel Rotor Block: Triangle (3 three magnet surfaces), Square (4 four magnet surfaces), Pentagon (5 five magnet surfaces), Hexagon (6 six magnet surfaces), Octagon (8 eight magnet surfaces), Rectangle (4 four magnet surfaces), cylinder (4 four magnet surfaces), or Disk shaped Block (4 four magnet surfaces); whereas the greater the number of geometric facets or magnet surfaces to a rotor block, the greater the rotational motion, output efficiency of the engine-motor-generator.

18. The apparatus according to claim 1, claim 4, claim 6, and claim 7, makes further claims of a “Magnetic Induction” construction method, where a “Magnetic Flywheel Induction Engine-Motor-Generator”, is constructed with a minimum of two (2) adjacently spaced monopole “Magnetic Flywheel Induction Rotors”, and separating the two flywheel rotors, and their respective unlike magnetic “north” and “south” poles facet surfaces, is an “Air Gap Distance” with typically a minimum distance, of one half the diameter of the magnet surface; and each left and right side of the magnetic flywheel rotor is connected to independent motor shafts and connecting hubs, where motors/generators/alternators are attached, thus, declared herein as a “Magnetic Induction” construction method.

19. The apparatus according to claim 18, makes further claims, for a “Magnetic Induction” process, which occurs when two (2) or more adjacently spaced “Magnetic Flywheel Induction Rotors” and their permanent magnet unlike pole facet surfaces, are separated from one another with a minimum “Air Gap Distance”, of one half the diameter of the magnet surface; and once the “Drive Motor/s” are powered and the “Magnetic Flywheel Induction Rotors” are in rotary motion, the interaction of the “Rotary Magnetic Fields” induces a new rotation into the air gap which causes rotation via magnetic induction of the “Magnetic Flywheel Inductor Rotor Blocks” about their respective motor shafts in the opposition direction to that which created the induction; and when attached to “Motor/Generators/Alternators” produce AC or DC electrical power, while simultaneously providing a means for generating mechanical work output, greatly improving the output efficiency of the engines, motor, and generators.

20. The apparatus according to claim 1, claim 4, claim 6, and claim 7, further claims, a “Magnetic Flywheel Induction Engine-Motor-Generator”, functions as an “AC Electrical Power Generator” when various coils of magnetic wire, are positioned in various ways around, and in the local vicinity of the rotatable “Magnetic Flywheel Induction Rotors”, and in the “Rotary Magnetic Fields” that they generate; the apparatus functions with or without a commutator, or slip-ring, and the output result is “AC Electrical Power” will be generated in the coils of wire.

21. The apparatus according to claim 1, claim 4, claim 6, and claim 7, further claims, a “Magnetic Flywheel Induction Engine-Motor-Generator”, closed system design that is “self-sustaining”, given, the system “Drive Motor” is powered by a “Rechargeable Battery” source, the “system” reacts “self-sustaining” by connecting the electrical output power, from one or more of the “DC/AC Electrical Motors/Generators/Alternators”, to a “Charge Controller”, or directly to the “Rechargeable Battery” source; the remaining “DC/AC Electrical Motors/Generators/Alternator/s”, output power, allows the apparatus to function as a “power-plant” and generator, which is “self-sustaining” recharging the battery source, while it produces AC/DC electrical power, and mechanical work.

22. The apparatus according to claim 1, claim 4, claim 6, and claim 7, further claims, a “Magnetic Flywheel Induction Engine-Motor-Generator”, can be utilized and constructed into an aircraft/marine propelling apparatus, when turbine/fan/blades are attached to the rotatable “Magnetic Flywheel Induction Rotors”, and engine nacelles are configured to fit cylindrically around the Magnetic Flywheel Induction Engine-Motor-Generator”, and attached to a aircraft/marine frame.

23. The apparatus according to claim 1, claim 4, claim 6, and claim 7, further claims, a “Magnetic Flywheel Induction Engine-Motor-Generator”, can be utilized and constructed into an automotive/motor cycle/scooter propelling apparatus, when some form of axle, rims and tires are attached to the rotatable “Magnetic Flywheel Induction Rotors”, and the “DC/AC Electrical Motors/Generators/Alternator/s”, which are configured and attached to a automotive/motor cycle/scooter frame.

24. The apparatus according to claim 1, claim 4, claim 6, and claim 7, further claims, a “Magnetic Flywheel Induction Engine-Motor-Generator”, can be utilized as an electrical power source for existing electric cars, by replacing the “rechargeable battery” of the electric car with the “Magnetic Flywheel Induction Engine-Motor-Generator”.

25. The apparatus according to claim 1, claim 4, claim 6, and claim 7, further claims, a “Magnetic Flywheel Induction Engine-Motor-Generator”, can be utilized and constructed into a “personal power plant”, such that when the “Drive Motors” are powered by a fossil fuel, wind energy, solar energy, or rechargeable battery source, the output power supplied by the “DC/AC Electrical Motors/Generators/Alternator/s when connected to a “Power Inverter” can be used to power houses, buildings, campers, hotels, etc; or when connected to a grid-tie inverter, can supply power back to a mains electricity power grid.
